(19) United States
(12) Patent Application Publication
(10) Pub. No.: US 2017/0053564 A1
(43) Pub. Date: Feb. 23, 2017

(54) MANIPULATIVE TREATMENT TRAINING SYSTEM AND METHOD, AND MANNEQUIN THEREFOR

(71) Applicant: CANADIAN MEMORIAL CHIROPRACTIC COLLEGE, Toronto (CA)

(72) Inventors: John J. TRIANO, Stouffville (CA); David STARMER, Richmond Hill (CA); Dominic GIULIANO, Vaughan (CA); Steve TRAN, Toronto (CA)

(21) Appl. No.: 15/299,328

(22) Filed: Oct. 20, 2016

Related U.S. Application Data
(63) Continuation-in-part of application No. PCT/CA2015/050324, filed on Apr. 17, 2015.

(30) Foreign Application Priority Data
Apr. 22, 2014 (CA) 2849224
Oct. 29, 2014 (CA) 2869514

(51) Int. Cl. G09B 23/30; G09B 5/02

(52) U.S. Cl. CPC G09B 23/30; G09B 5/02

(57) ABSTRACT

Described herein are various embodiments of a manipulative treatment training system and method to provide constructive feedback to candidates practicing selected training actions on a mannequin to learn or improve certain treatment methods and techniques, and thus, thereafter provide more accurate and/or safe treatment to patients.

### FIELD OF THE DISCLOSURE

The present disclosure relates to training systems, and in particular, to a manipulative treatment training system and method, and mannequin therefor.

### BACKGROUND

Professional training for the safe and effective manipulation of patients in the provision of manipulative therapeutic treatments, such as in physiotherapy, massage therapy, chiropractic treatment, and the like, generally involves many hours of hands-on training and practice to ensure that prospective therapists learn safe and effective treatment methods and techniques. While various teaching techniques have been devised to progressively initiate prospective therapists to actual patient manipulation, these techniques generally rely on qualitative measures and observational mentoring rather than on quantitative performance measures. Namely, accurate quantitative measures of a candidate's efficacy in the implementation of learned treatment procedures and techniques are generally lacking, which may lead to inadequate or incomplete training and potential risks of injury to volunteer training subjects and/or future patients of these candidates post-training.

Some training tools and techniques, for example in the teaching and assessment of chiropractic treatment techniques and procedures, have been proposed to provide training candidates with some constructive feedback before practicing training exercises on live subjects. J. J. Triano et al. report on such tools and techniques in Biomechanics—Review of approaches for performance training in spinal manipulation, Journal of Electromyography and Kinesiology 22 (2012), 732-739, the entire contents of which are hereby incorporated herein by reference.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for manipulative treatment training systems and methods, and mannequin therefor, that overcome some of the drawbacks of known techniques, or at least, provide a useful alternative thereto. Some aspects of this disclosure provide examples of such systems.

In accordance with one embodiment, there is provided a training mannequin for training in the performance of at least one manipulative treatment procedure, the mannequin comprising: a rigid anatomically-scaled artificial human spine structure embedded within a resilient foam compound shaped to anatomically reproduce at least a human torso model; and at least one sensor disposed within said human torso model in a designated region of interest, wherein said sensor is responsive to an external force applied to said torso model through said foam during the procedure in providing at least one measure representative of said applied force as felt within the mannequin for visualisation on a graphical user interface during training; wherein a composition of said foam is selected to exhibit a compliance substantially consistent with an estimated compliance of live human torso soft tissue such that said compliance is accounted for in applying said force.

In accordance with another embodiment, there is provided a manipulative treatment mannequin for training in the performance of at least one manipulative treatment procedure, the mannequin comprising: an anatomically-scaled human torso model having disjoint upper and lower portions; and a sensing unit structurally anchored between said upper and lower portions along a spinal region thereof so to permit relative articulation of said upper and lower portions, said sensing unit comprising a sensor disposed along said spinal region to output a measure indicative of said relative articulation in response to application of the at least one manipulative treatment procedure to the mannequin.

In accordance with another embodiment, there is provided a manipulative treatment mannequin for training in the performance of at least one manipulative treatment procedure, the mannequin comprising: an anatomically-scaled human torso model having a torso sensor operatively mounted therein to output a kinematic torso measure indicative of a kinematic torso response to a given procedure; and an anatomically-scaled human head model flexibly coupled to said torso model and having a head sensor operatively mounted therein to output a kinematic head measure indicative of a kinematic head response to said given procedure and comparable with said kinematic torso measure to output relative treatment procedure kinematics representative of said given procedure as a training feedback measure.

In accordance with another embodiment, there is provided a manipulative treatment training system comprising: a mannequin as defined above to be positioned in one or more designated treatment configurations to perform a selected manipulative treatment procedure; and a graphical user interface operable to graphically render training feedback data processed from each said measure output from said mannequin during performance of said selected manipulative treatment, wherein said training feedback data is representative of said performance.

In accordance with another embodiment, there is provided a manipulative treatment training method comprising: positioning a mannequin as defined above in a designated treatment configuration; having a training candidate perform a selected manipulative treatment procedure on said mannequin; acquiring each said measure output from said mannequin during performance of said selected treatment procedure; and graphically rendering training feedback data processed from each said acquired data as representative of said performance as visual feedback.

In accordance with another embodiment, there is provided a manipulative treatment training system comprising: a support platform for supporting a subject or training mannequin, said support platform having one or more load sensors operatively associated therewith to output a signal indicative of a load applied to at least part of said support platform via said subject or mannequin while performing a selected one of multiple designated manipulative treatment procedures thereon; a graphical user interface defining a treatment-selection tool allowing user-selection of said selected procedure from said multiple designated treatment procedures, and graphically rendering a procedure-specific data output derived from said signal; a computer-readable medium having stored thereon a respective procedure-specific calibration metric for each of said multiple designated treatment procedures; and a data processor operatively associated with said computer-readable medium and graphical user interface, said processor, responsive to said user-selection of said selected procedure via said graphical user interface, applying said respective procedure-specific calibration metric associated with said selected procedure to said signal to output said procedure-specific data to said graphical user interface.

In accordance with another embodiment, there is provided a non-transitory computer-readable medium having statements and instructions stored thereon for implementation by a digital data processor to operate a manipulative treatment training system in: graphically rendering a treatment-selection tool allowing user-selection of a selected manipulative treatment procedure from multiple designated treatment procedures; responsive to said user-selection, accessing a given digital procedure-specific calibration metric from a data store of such metrics respectively associated with each of said multiple designated treatment procedures; acquiring an applied load signal output in response to performance of said selected manipulative treatment procedure; applying said given procedure-specific calibration metric to said signal to output calibrated procedure-execution feedback data; and graphically rendering said calibrated procedure-execution feedback data.

In accordance with another embodiment, there is provided a manipulative treatment method comprising: graphically rendering a treatment-selection tool allowing user-selection of a selected manipulative treatment procedure from multiple designated treatment procedures; responsive to said user-selection, accessing a given digital procedure-specific calibration metric from a data store of such metrics respectively associated with each of said multiple designated treatment procedures; acquiring an applied load signal output in response to performance of said selected manipulative treatment procedure; applying said given procedure-specific calibration metric to said signal to output calibrated procedure-execution feedback data; and graphically rendering said calibrated procedure-execution feedback data.

In accordance with another aspect, there is provided a manipulative treatment training system comprising: a support platform for supporting a subject or training mannequin, said support platform having one or more load sensors operatively associated therewith to output a signal indicative of a load applied over time to at least part of said support platform via said subject or mannequin while performing a selected one of multiple designated manipulative treatment procedures thereon; a graphical user interface defining a treatment-selection tool allowing user-selection of said selected procedure from said multiple designated treatment procedures, and graphically rendering a procedure-specific data output derived from said signal; a computer-readable medium having stored thereon a respective procedure-specific calibration metric for said selected treatment procedure; and a data processor operatively associated with said computer-readable medium and graphical user interface, said processor, responsive to said user-selection of said selected procedure via said graphical user interface, applying said respective procedure-specific calibration metric associated with said selected procedure to said signal to output said procedure-specific data to said graphical user interface; wherein said respective procedure-specific calibration metric accounts for at least one of a predefined relative vectorial distance and direction of said selected procedure to vectorially re-center said output data consistent with a designated load application configuration for said selected procedure; and wherein said output procedure-specific data comprises vectorially re-centered procedure-specific load-related time profiles extrapolated from said load applied over time.

In accordance with another aspect, there is provided a non-transitory computer-readable medium having statements and instructions stored thereon for implementation by a digital data processor to operate a manipulative treatment training system in: graphically rendering a treatment-selection tool allowing user-selection of a selected manipulative treatment procedure from multiple designated treatment procedures; accessing a given digital procedure-specific calibration metric from a data store associated with said selected manipulative treatment procedure; acquiring an applied load signal output over time in response to performance of said selected manipulative treatment procedure; applying said given procedure-specific calibration metric to said signal to output calibrated procedure-execution feedback data; and graphically rendering said calibrated procedure-execution feedback data; wherein each said given procedure-specific calibration metric accounts for at least one of a predefined relative vectorial distance and direction of said selected treatment procedure to vectorially re-center said applied load signal output consistent with a designated load application configuration for said selected treatment procedure; and wherein said calibrated procedure-specific feedback data comprises vectorially re-centered procedure-specific load-related time profiles extrapolated from said applied load signal over time.

In accordance with another aspect, there is provided a computer-implemented manipulative treatment training method comprising: graphically rendering, via a digital processor, a treatment-selection tool allowing user-selection of a selected manipulative treatment procedure from multiple designated treatment procedures; accessing, via said digital processor, a given digital procedure-specific calibration metric from a data store associated with said selected manipulative treatment procedure; acquiring, via said digital processor, an applied load signal output over time in response to performance of said selected manipulative treatment procedure; applying, via said digital processor, said given procedure-specific calibration metric to said signal to output calibrated procedure-execution feedback data; and graphically rendering, via said digital processor, said calibrated procedure-execution feedback data; wherein said procedure-specific calibration metric accounts for at least one of a predefined relative vectorial distance and direction of said selected procedure to vectorially re-center said output data consistent with a designated load application configuration for said selected procedure; and wherein said output procedure-execution feedback data comprises vectorially re-centered procedure-specific load-related time profiles extrapolated from said applied load signal over time.

Other aspects, features and/or advantages will become more apparent upon reading of the following non-restrictive description of specific embodiments, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is an anterior elevation view along the coronal plane of a training mannequin showing in ghost lines a partial skeleton embedded therein, in accordance with one embodiment of the invention;

FIG. 2 is a posterior elevation view along the coronal plane of the training mannequin of FIG. 1;

FIG. 3 is a side view along the sagittal plane of the training mannequin of FIG. 1;

FIG. 4 is a mid-sagittal view of the mannequin of FIG. 3;

FIG. 5 is a posterior elevation view of a training mannequin showing in ghost lines a partial skeleton and a pair of pressure-sensitive sensors embedded therein;

FIG. 6 is a mid-sagittal view of the mannequin of FIG. 5;

FIG. 7 is a perspective view of a manipulative treatment training system in which the mannequin of FIG. 5 is used for training on an applied load-sensing treatment table, in accordance with one embodiment of the invention;

FIG. 8 is a side view of a manipulative treatment training system in which the mannequin of FIG. 5 is used for training on an applied load-sensing treatment table, in accordance with another embodiment of the invention;

FIG. 9 is a perspective view of the treatment table of FIG. 8;

FIG. 10 is a perspective view of a manipulative treatment training system in which either of the mannequin of FIG. 1 or FIG. 5 is used for training on an applied load-sensing treatment table, and in which one or more video recorders are used to provide concurrent video feedback;

FIG. 11 is a perspective of a base for an independent head support portion of a load-sensing treatment table, in accordance with one embodiment of the invention;

FIG. 12 is a side elevation view of a head support portion mountable to the based of FIG. 11, in accordance with one embodiment of the invention;

FIG. 13 is a top plan view of the head support portion of FIG. 12;

FIGS. 14 to 20 are screen shots of a graphical user interface for rendering data acquired via a load-sensing table and processed in accordance with one or more procedure-specific functions selectable from the graphical user interface, in accordance with one embodiment of the invention;

FIG. 21 is a perspective diagrammatical view of a training mannequin, in accordance with another embodiment of the invention, having articulated neck and lumbar portions, an embedded lumbar load sensing unit and embedded relative head and torso kinematics sensors;

FIG. 22 is a perspective view of the lumbar load sensing unit of FIG. 21;

FIG. 23 is a rear perspective view of an anatomically-scaled rigid human torso model having upper and lower portions flexibly joined by the lumber load sensing unit of FIG. 21 and that together, define a substantially continuous set of anatomically-shaped spine surface features, in accordance with one embodiment of the invention;

FIG. 24 is a rear perspective view of the torso model of FIG. 23 once covered with a resilient foam compound to exhibit a compliance substantially consistent with an estimated compliance of live human torso soft tissue;

FIGS. 25 to 31 are screen shots of a graphical user interface for rendering data acquired via a load-sensing table and processed in accordance with one or more procedure-specific functions selectable from the graphical user interface, in accordance with another embodiment of the invention.

### DETAILED DESCRIPTION

In accordance with some aspects of the herein-described embodiments, manipulative treatment training systems and methods are described to provide constructive feedback to candidates practicing selected training actions on a mannequin to learn or improve certain treatment methods and techniques, and thus, thereafter provide more accurate and/or safe treatment to patients.

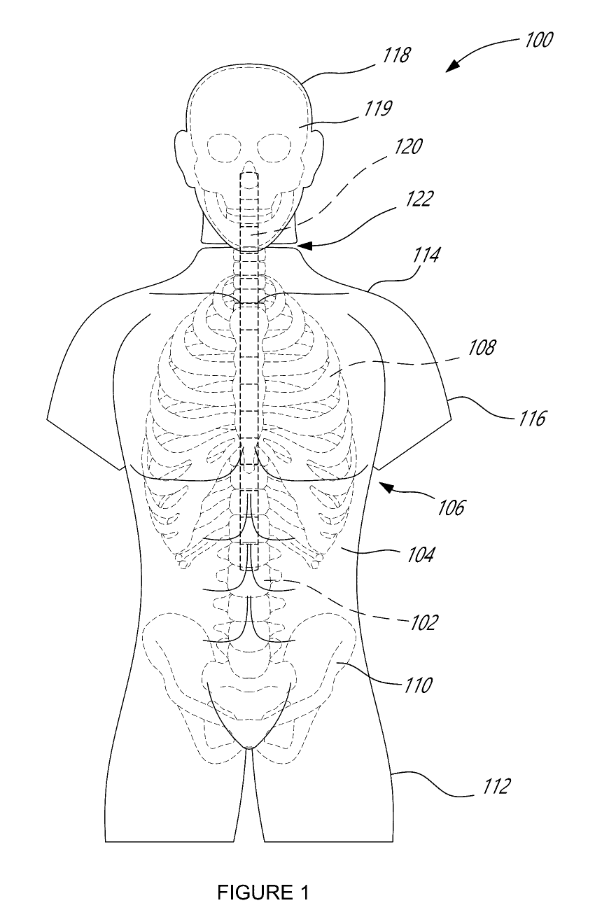

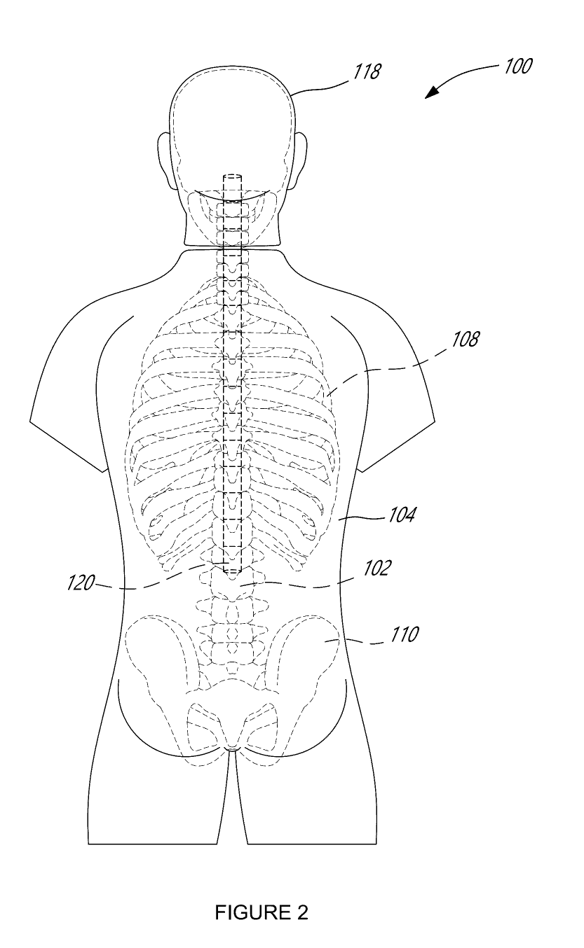

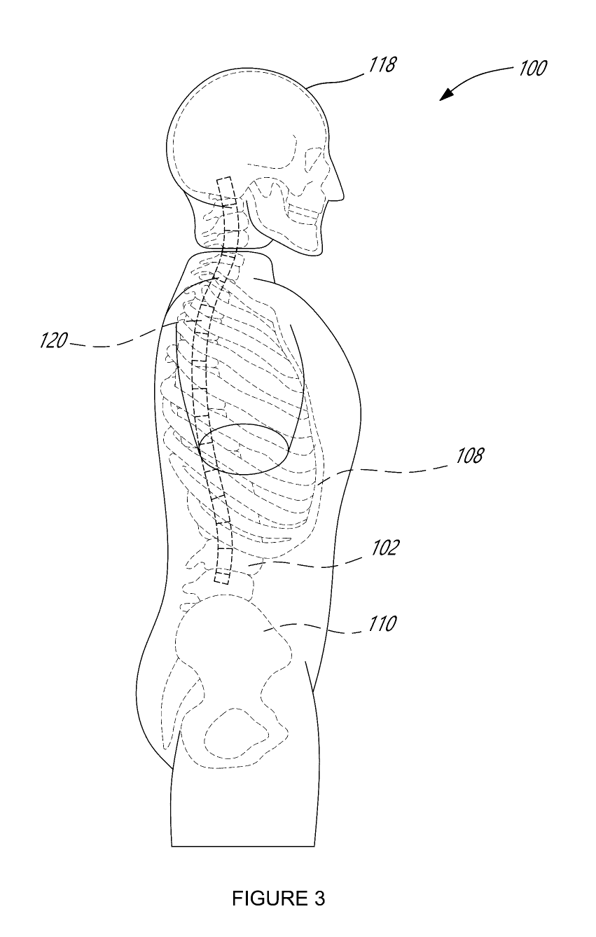

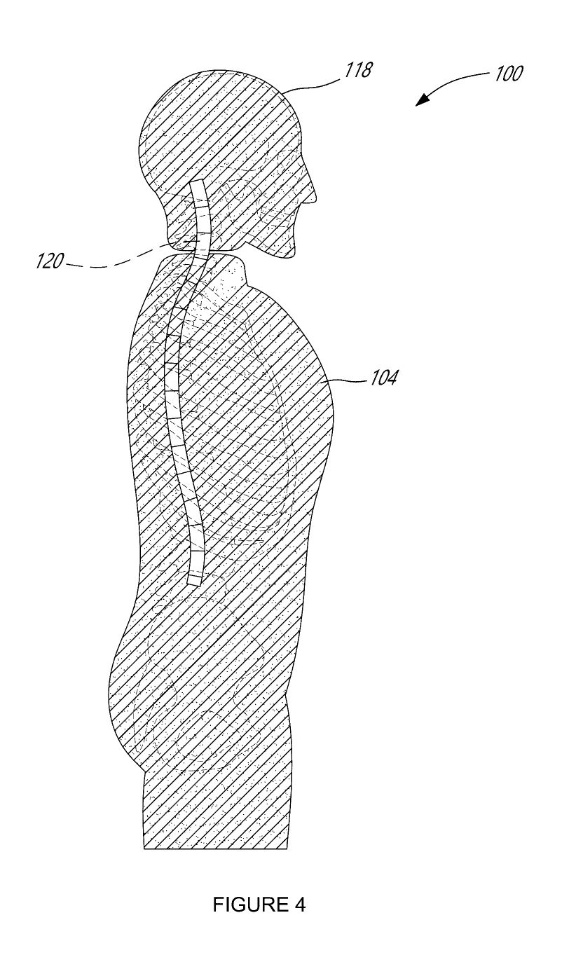

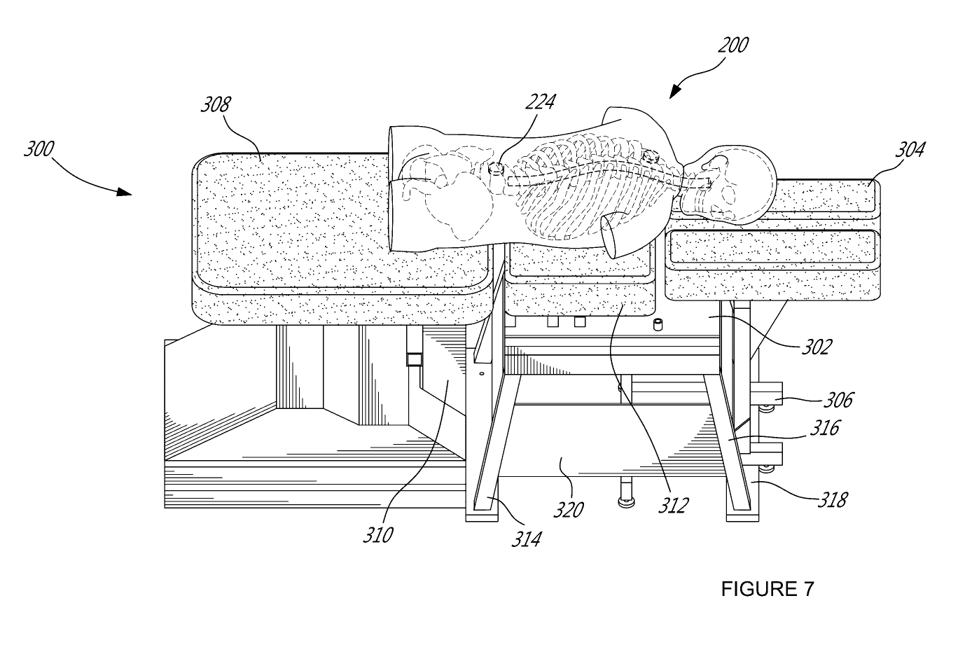

With reference now to FIGS. 1 to 4, and in accordance with one embodiment, a training mannequin, generally referred to using the numeral 100 and described herein, in accordance with different embodiments, within the context of a manipulative treatment training system (e.g. as seen in FIGS. 7, 8 and 10), will now be described. In this embodiment, the mannequin 100, generally comprises an anatomically-scaled artificial human spine structure 102 embedded within a foam compound 104 shaped to anatomically reproduce at least a human torso 106. In this particular embodiment, the spine structure consists of a commercially available articulated plastic human spine model, however, further embodiments described below are shown to alternatively comprise a set of anatomically-shaped spine surface features cast, moulded or otherwise moulded within rigid upper and lower torso model portions, for example. In the embodiment of FIGS. 1 to 4, the embedded spine 102 has coupled thereto a corresponding rib cage 108 and pelvis 110, and is correspondingly shaped to include not only a torso 106, but to also extend down to include upper thighs 112 as well as shoulders 114 and upper arms 116. The mannequin 100 further comprises, in this embodiment, an anatomically-scaled head 118 flexibly coupled to the spine 102 via a flexible coupling 120 thereby allowing for substantively physiologically accurate positioning of the head 118 relative to the torso 106 in positioning the mannequin 100 during training.

While the illustrated embodiment considers a head 118 having a skull 119 embedded in a foam-surround head casing, it will be appreciated that, depending on the intended use of the mannequin, such complexity may not be required, and the head may rather consist of a simple plastic head or the like. Likewise, and as introduced above, while an articulated spine model, ribs and pelvis are considered in this embodiment, other embodiments as shown below may be otherwise configured to provide a similar solution, such as via a formed or molded rigid torso model, optionally embedded within a similar foam compound to reproduce soft-tissue compliance to the touch.

In the illustrated embodiment, the flexible coupling 120 consists of articulated or deformable metal tubing (or other suitable material, for example a plastics material) or shaft such as those commonly used as deformable conduits in the fabrication of articulated lamps or like mechanically articulable joints. Other examples may include a bundle of soft alloy steel, a resilient material, and/or other flexible/articulated structures allowing for the realistic manipulation and positioning of the head 118 relative to the torso 106. In order to allow for greater head motion, the foam 104 embodying the torso 106 is disjoint from the head (i.e. see gap 122). Accordingly, upon further coupling the flexible coupling 120 to the head 118 via a rotational coupling (e.g. rotational bearing, not explicitly shown), the head 118 may be more readily rotated from side to side relative to the torso 106, thus allowing for a more accurate positioning of the mannequin 100 while training with different treatment positions.

In this embodiment, the composition of the foam 104 is selected to exhibit a compliance substantially consistent with an estimated compliance of live human soft tissue such that this compliance is accounted for in applying an external pressure to the mannequin 100 during training exercises. For example, the foam compliance may be such to provide a relatively realistic tactile sensation to the candidate while training with the mannequin, thus allowing the candidate to better gauge an appropriate pressure to be applied to the mannequin in performing various treatment procedures, for example in the performance of chiropractic training procedures on the mannequin's internal spine 102 or related components. Coupled with the system as a whole or through imbedded pressure sensors, for example and as described below, the tactile pressure can be measured to provide feedback for training of appropriate forces for patient assessment. As will be described in greater detail below, the provision of a realistic material compliance akin to live human tissue not only allows the trainee to get a better sense of what he or she will feel once they start training on live candidates, and ultimately patients, but also provide a more realistic feedback when gauging and evaluating external pressures applied to the mannequin during training so as to effectively carry out a given procedure.

In accordance with some embodiments, the foam compliance is selected to have a deformational resiliency in the order of from about 0.12 mm/N to about 0.43 mm/N. Such a deformational resiliency has been experimentally observed to encompass standard tissue compliance in the relevant sections of the human body. In one example, the foam consists of High Resilience (HR) polyurethane foam with a density of 3.0 +/−10% pounds per cubic foot and firmness (ILD) of 25 +/−10% pounds force (ASTM D3574 for polyurethane foam). In yet other embodiments, the foam compliance is selected in accordance with a particular body type to be represented by the mannequin in question. For example, a mannequin built to mimic manipulative treatments performed on patients characterized as having a higher percentage of body fat than considered ideal (e.g. endomorph) may be manufactured of a foam having a lower compliance than that for a similar mannequin built for training on a simulated average or lesser than ideal percentage body fat or composition (e.g. mesomorph or ectomorph).

In some embodiments, in order to achieve the above-noted material compliances, the selected foam material may consist of a two-component rigid polyurethane foam system such as GENYK B-1150/A-2732 manufactured by Genyk™ (Grand-Mere, QC).

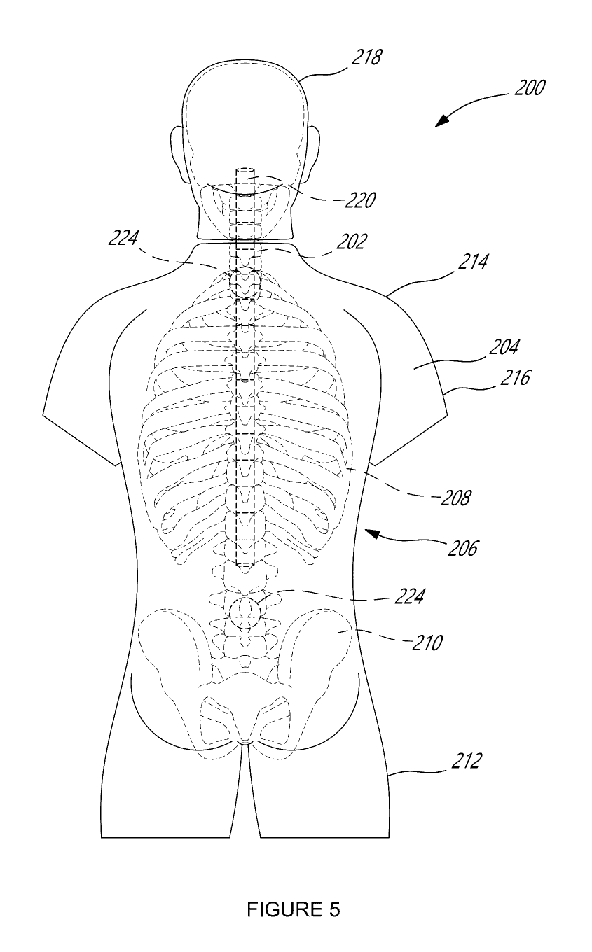

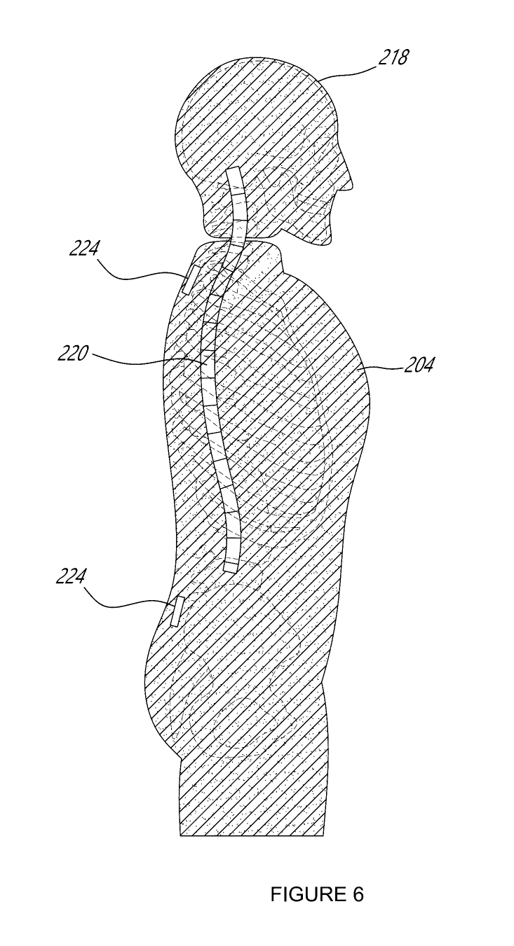

With reference now to FIGS. 5 and 6, and in accordance with another embodiment, a training mannequin 200 is shown to generally comprise, much like the mannequin 100 described above with reference to FIGS. 1 to 4, an anatomically-scaled artificial human spine 202 embedded within a foam compound 204 shaped to anatomically reproduce at least a human torso 206. In this embodiment, the embedded spine 204 again has coupled thereto a corresponding rib cage 208 and pelvis 210, and is correspondingly shaped to include not only a torso 206, but to also extend down to include upper thighs 212 as well as shoulders 214 and upper arms 216. The mannequin 200 further comprises, in this embodiment, an anatomically-scaled head 218 flexibly and rotationally coupled to the spine 202 via a flexible coupling 220 thereby allowing for substantively physiologically accurate positioning of the head 218 relative to the torso 206 in positioning the mannequin 200 during training.

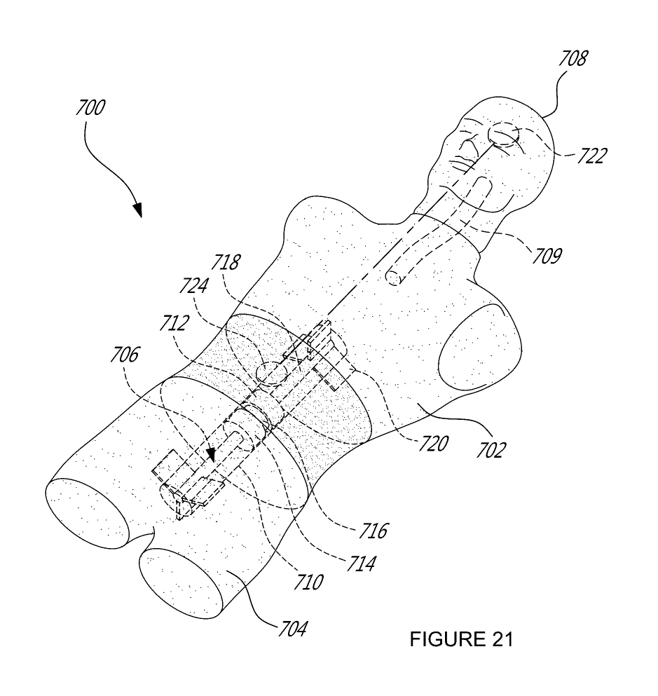

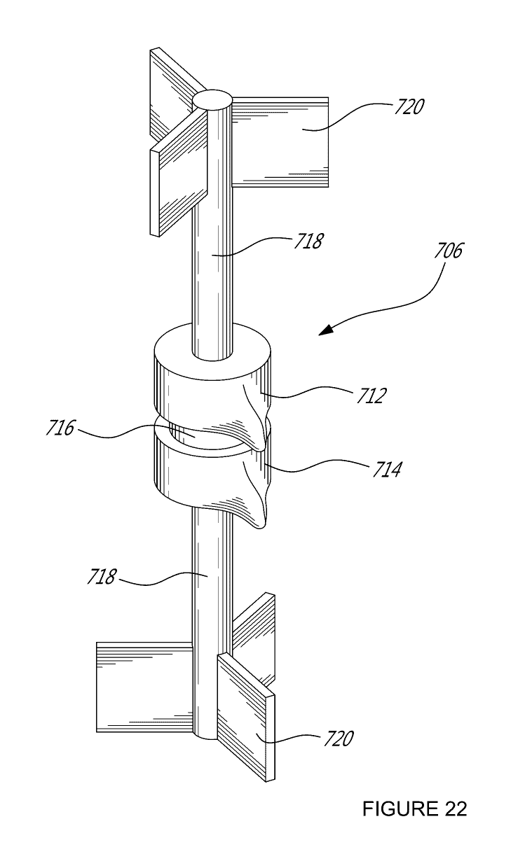

In another embodiment, the low back region of the mannequin may also be fitted with an articulated member, such as described below with reference to FIGS. 21 to 24, allowing axial rotation about the central spine member, simulating patient response to preload forces prior to application of treatment. Such preload forces may be measured by an embedded sensor, such as sensor 224 noted below, and/or by a table force plate (e.g. see force plate 302 of FIG. 7) and used to train for appropriate preload amplitudes. As described with reference to FIGS. 21 to 24 below, flexion/extension and lateral bending may also be further or alternatively allowed by proper selection of component materials or by the incorporation of artificial joints or flexures to mimic biologic fidelity during execution of training procedures. For example, such benefits may be achieved by proper selection of materials in the manufacture of the lumber load sensing unit 706 described with reference to FIG. 22, and particularly of the spaded anchors 720 thereof, for example.

In this particular embodiment, the mannequin further comprises one or more embedded sensors 224, illustrated generically in this example as positioned relative to the upper lumbar and lower cervical/upper thoracic regions of the spine. However, such sensors may be placed at one or more additional locations relative the spine 202. For example, the mannequin 200 may include embedded therein at least one pressure-sensitive sensor, such as sensors 224, to respond to an external pressure applied to the torso 206 (and/or other regions) through the foam 204 in providing a direct measure of this external pressure as felt within the mannequin body for visualization on a graphical user interface during training (e.g. as discussed in greater detail below). Sensors 224 may also be embedded, or otherwise placed, between various vertebrae; for example in the intervertebral space normally occupied by intervertebral discs (not shown). By embedding the sensors 224 along the artificial spine 202 and within the compliance-specific foam 204, not only may the practitioner be provided with a more accurate tactile sense during performance of various training procedures, but also be provided with direct feedback as to an actual applied pressure to the artificial spine 202 or area. Accordingly, estimated live tissue compliance within a given area of the body and thus a more realistic required treatment pressure applied to the training mannequin 200 is provided to the practitioner so as to learn or hone a given procedure.

In one example, the embedded sensors are more adequately shaped and sized to be positioned between the vertebrae of the artificial spine. Suitable sensors for such embodiments may include, but are not limited to, the AT Industrial Automation Mini45 F/T sensor (Apex, N.C.), which, at approximately 45 mm in diameter and 17.5 mm in height, can readily be inserted between selected vertebra to provide useful results without interfering with the user's tactile experience with the mannequin. Other sensors may be equally suitable, as will be readily appreciated by the skilled artisan.

While the above examples contemplate force/moment sensors, other sensor types may also be considered, alone or in combination, without departing from the general scope and nature of the present disclosure. For example, different pressure, force, tension, strain, acceleration and/or gyroscopic sensors may also be considered for use as different sites of interest to report on local applied forces, relative strain/deformation, and/or inertial motions, to name a few.

As will be appreciated by the skilled artisan, and noted above, different numbers of sensors 224 can be embedded to provide greater or lesser training versatility and feedback to the practitioner. Furthermore, different sensor locations may also be considered depending on the intended treatment training procedures contemplated.

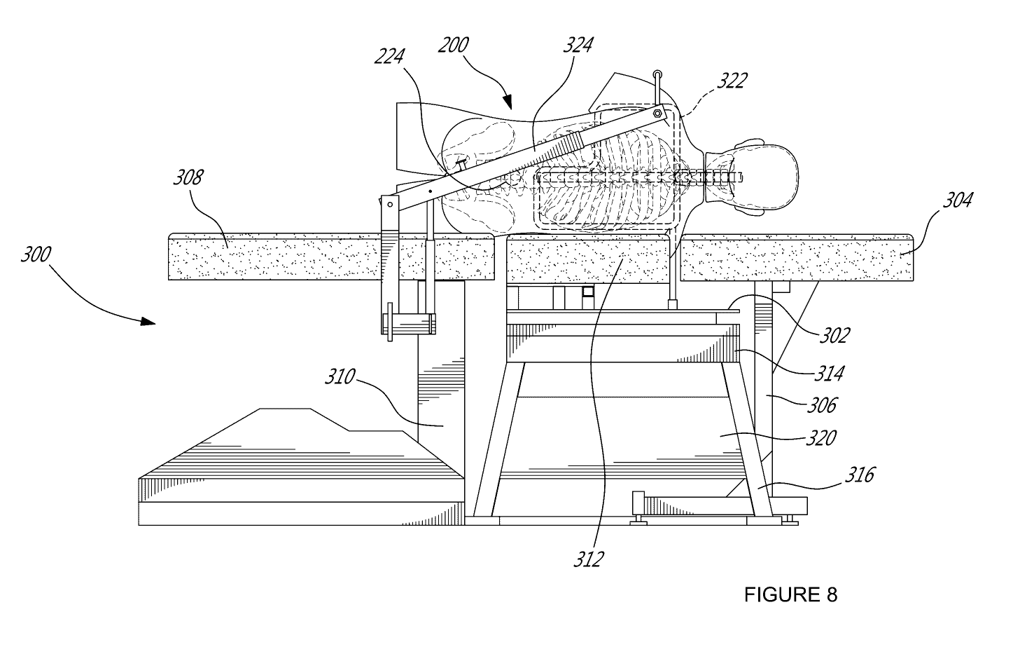

With reference now to FIGS. 7 to 9, and in accordance with one embodiment, the mannequin 200 of FIGS. 5 and 6 is illustrated for use in training in combination with a training support platform 300. In this example, the platform 300 is provided, much like a standard manipulative treatment table, to support the mannequin 200 in one or more designated treatment configurations. In the example of FIG. 7, the mannequin 200 is supported on its chest with its head turned sideways, whereas in the example of FIG. 8, the mannequin is rather positioned on its side, as will be discussed in greater detail below. As will be appreciated by the skilled artisan, the mannequin may also be positioned on its back for simulation of some thoracic spine manoeuvres and/or for cervical spine manoeuvres.

In this particular example, the platform 300 has one or more load sensors, as in load-plate 302, operatively associated therewith to output a signal indicative of a load applied to at least part of the support platform 300 via the mannequin 200 during use. Accordingly, an external pressure applied to the mannequin will not only be directly captured by one or more of the mannequin's embedded sensors 222, but also observed indirectly by the load-plate 302 of the support platform 300, which may both be concurrently rendered on a graphical user interface of immediate feedback to the trainee during use, or again as playback for subsequent analysis (e.g. as discussed in greater detail below).

In this particular embodiment, the platform comprises a head support portion 304 having a base 306, a leg support portion 308 having a base 310 (i.e. in this embodiment a powered articulated base providing oscillating movements as with some forms of assisted manipulation procedures and as commercially available in the 950 Series tables manufactured by Leander Healthcare Technologies, Kansas, US), and a thoracic support portion 312 itself having an independent base 314 to which is operatively mounted the load plate 302 (i.e. between the base 314 and thoracic support portion 312). While the head support portion base 306 and leg support portion base 310 may be integrally coupled or disjoint (the former option providing a more reproducible relative positioning, the latter being easier to move piecewise), the thoracic support portion 312 and base 314 are generally structurally independent from both the head support portion 304 and the leg support portion 308 such that a load applied to the thoracic support portion 312 may be isolated for processing and analysis. This may thus allow for a measure and ultimate visualization of a load applied to the mannequin's thorax to provide qualitative and/or quantitative feedback to the user. Using inverse dynamics methods, as described further below, certain procedures applied to the neck, low back or pelvis may also be visualized when appropriate procedural constraints are employed. Other examples may also include, but are not limited to, a fixed/locked head support portion, a head and/or leg support portion with a cam-drop mechanism, and a head support portion on rollers to emulate different prone and supine cervical spine and thoracic spine manoeuvres with fidelity of measure.

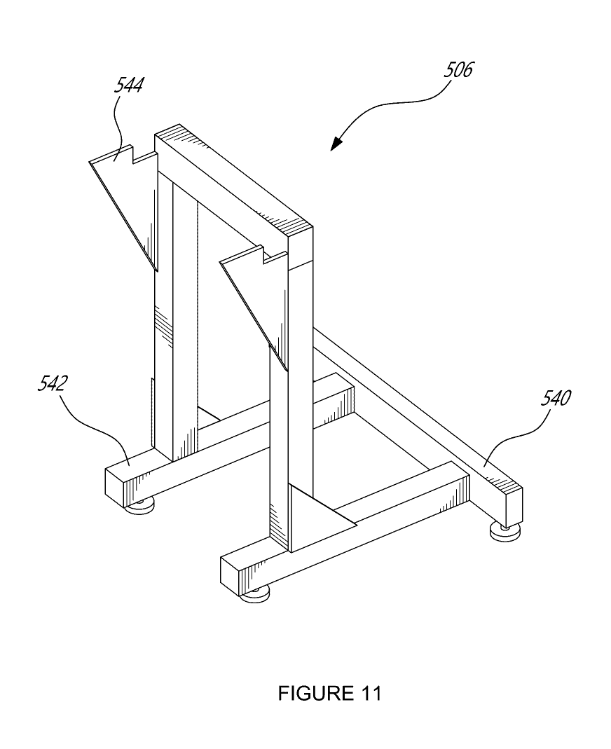

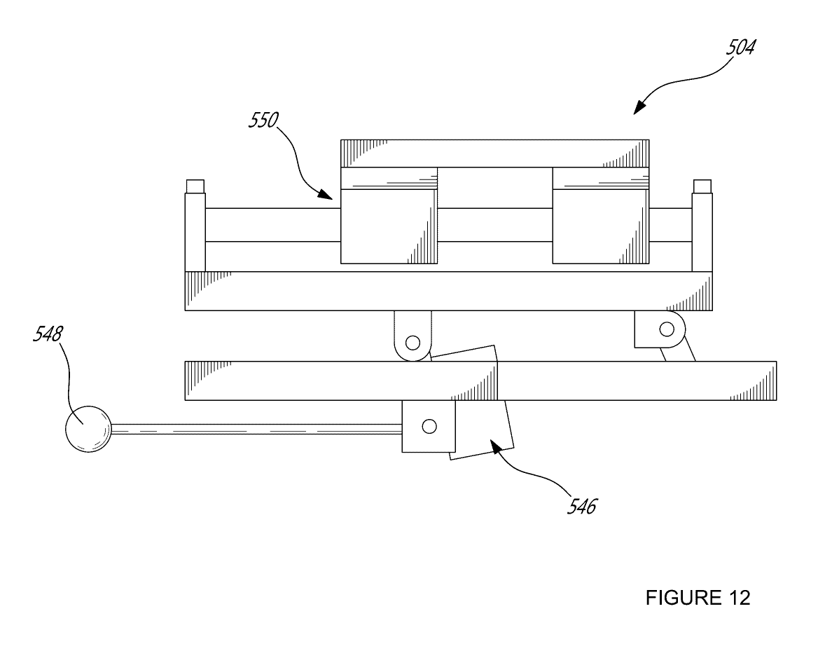

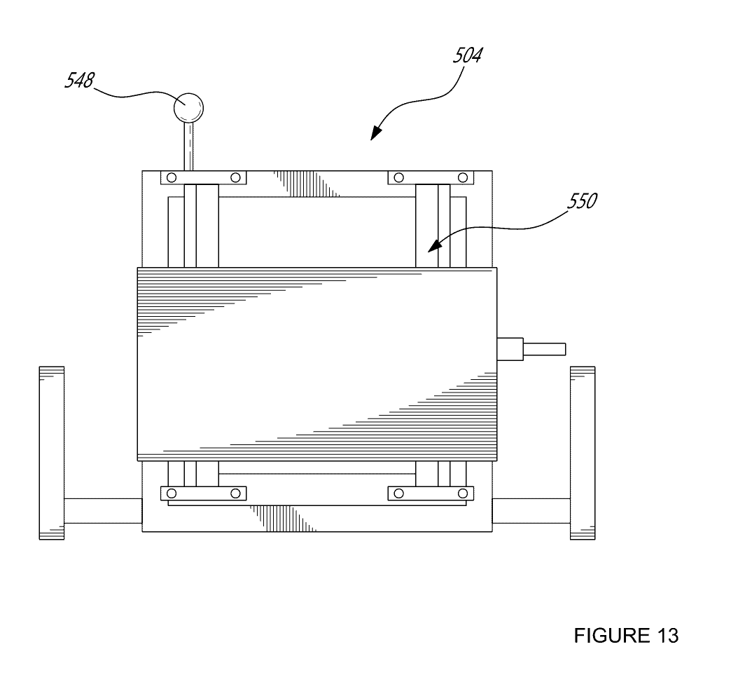

For instance, and with reference to an alternative embodiment shown in FIGS. 11 to 13, an alternative head support portion 504 (FIGS. 12 and 13) may include an independent base 506 (FIG. 11) that can be independently positioned relative to the thoracic support portion 312 and leg support portion 308 shown FIGS. 7 and 8. Again, the base 506 may include a set of lower laterally extending and stabilizing feet 540 that can be positioned to rest below and extend outwardly from the thoracic support portion 312, and a set of upper direct load bearing feet 542 positioned more or less vertically below a head portion support structure 544. In the particular example of FIGS. 12 and 13, the head support portion 504 includes a cam-drop mechanism 546 generally operated via actuation of lever 548 (e.g. as commercially available in the 950 Series tables manufactured by Leander Healthcare Technologies, Kansas, US). A similar mechanism may also be included in the lower body support portion 310. The head portion further comprises an optional lockable axial head slide mechanism 550 that can improve subject comfort during certain procedures as the head support portion and the subject's head may be allowed to glide naturally during treatment when in the unlocked position, or kept static when in the locked position. In addition, while the natural movement of the head using the gliding headpiece during certain procedures may increase user comfort, it may also increase an accuracy of readings taken via the system's load plate during certain procedures. For example, while direct or indirect thoracic loads are more or less isolated by keeping the thoracic support portion independent from the head and leg support portions, during certain procedures, resistance exerted by the head when using a static headpiece may obscure some of the finer details of the data extracted via the load plate. Accordingly, by allowing the training subject or mannequin's head to move naturally in an axial direction during certain procedures of concern, as enabled by the illustrated embodiment of FIGS. 12 and 13, resistance at the head that would otherwise be exerted can be reduced if not altogether minimized or avoided to produce more accurate load readings and outputs. Therefore, the use of axial rollers or slides, as contemplated in the embodiment of FIGS. 12 and 13, can provide a significant improvement in overall data capture and accuracy.

With reference back to the embodiment of FIGS. 7 and 8, the thoracic base 314 consists of a stable structure having four outwardly splayed legs 316 coupled in pairs at their feet via a pair of cross flat bars 318, the pairs themselves braced to one another via cross lateral walls 320, the combination of which balancing structural integrity and weight to allow for ease of use and transport, while allowing for the use of an independently stabilized head support portion 304 and base 306 (or portion 504 and based 506 of FIGS. 11 to 13).

In some embodiments, the load plate 302 consists of a multi-axis force plate configured to output a signal indicative of a force applied to the mannequin along two or more axes (e.g. Fx, Fy and Fz). In one such embodiment, the multi-axis force plate is further configured to output a signal indicative of a moment of force or force couple applied to the mannequin about two or more axes (e.g. Mx, My, Mz).

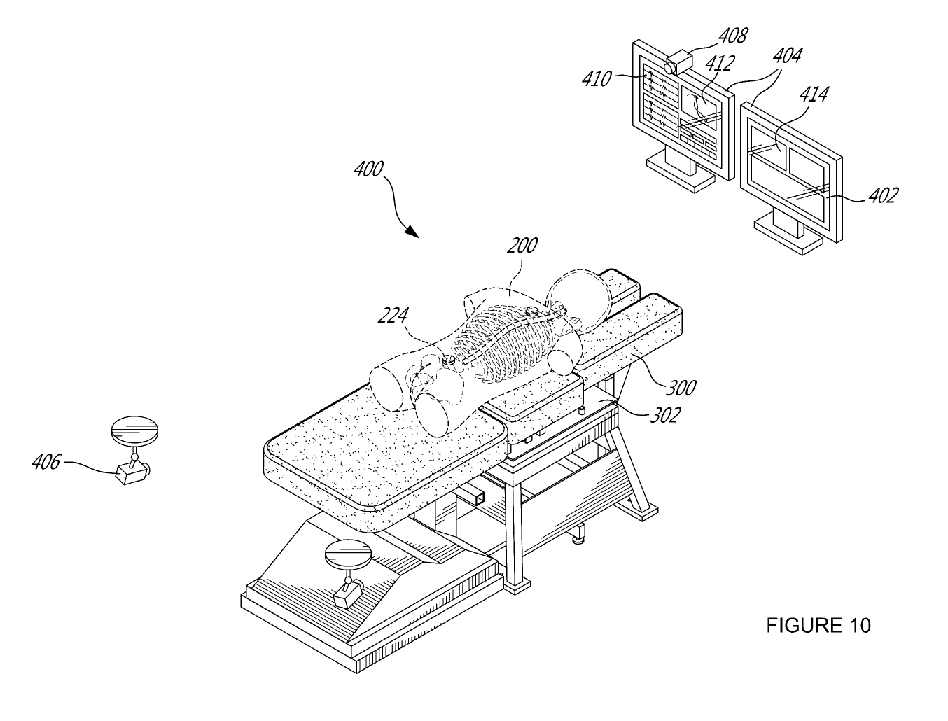

In one such example, the selected force plate consists of a sensing platform manufactured by Advanced Mechanical Technologies Inc. (AMTI-Watertown, Mass.) capable of recording forces and moments in three dimensions and output analog force and moment channels for each of the X, Y and Z axes. Force-time profiles can thus be recorded electronically by connection of the force plate strain gauge ensembles through an analogue amplifier, and finally digitized at 200 HZ, 300 HZ or other desired acquisition rates across all 6 channels (3 forces, 3 moments) using a Matlab Data Acquisition system (Mathworks, Natick, Mass.), for example. Profiles can then be post-processed, for example again using MatLab software, to represent the force-time profiles (e.g. discussed in greater detail below with reference to FIG. 10) in anatomically meaningful formats. For instance, reverse dynamics can be used against designated treatment training techniques while accounting for an estimated body position and orientation respective thereto, to extrapolate an approximate treatment load transmitted through a region of interest or applied to the mannequin at the point of contact. In general, post processing techniques may be used to filter acquired raw signals; set window regions of interest; time-link all measures; allow user-selected quantization of specific points within the force-time profiles; calculate derived variables such as the rate of rise, accelerations (e.g. jerk) and direction of force/moment applications; etc. As will be discussed in greater detail below, post-processing techniques may also take into account a preselected data acquisition mode, and a simulation/mobilization option such as, but not limited to, identifying a particular area of the body and/or a particular procedure to be applied thereto. Any such processing may be used alone or in combination to prepare the signal prior to being rendered on the graphical user interface for visualization in a more meaningful and instructive format. Other processing techniques may also be considered, as will be appreciated by the skilled artisan, without departing from the general scope and nature of the present disclosure.

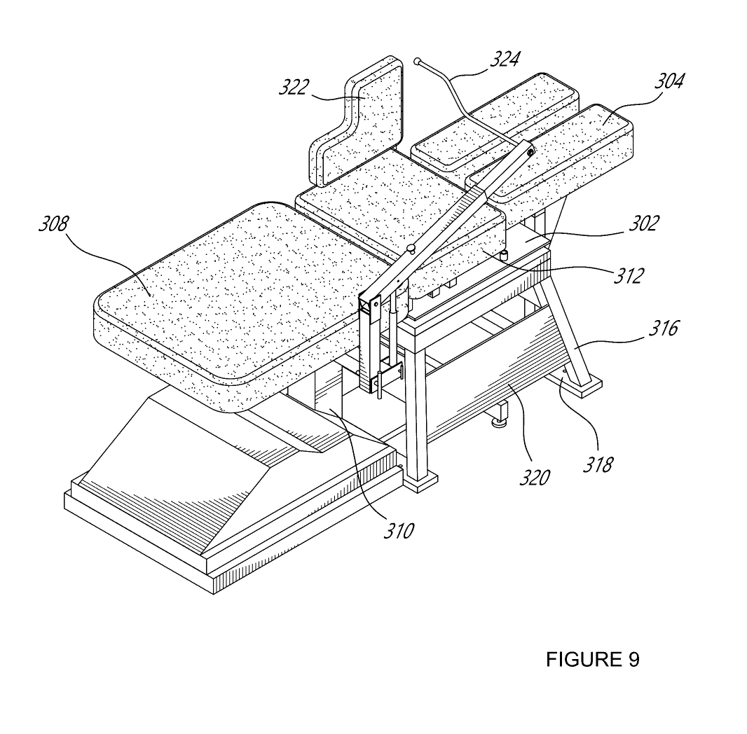

With particular reference now to FIGS. 8 and 9, the mannequin 200 is shown in a side-lying configuration with the further aid of lateral side-lying positioning pad 322 and adjustable trainee weight support 324. Given this alternative arrangement, a trainee may practice procedures to be implemented on a side-lying subjects while still benefiting from the load-plate 302 and embedded sensors 222. For instance, in this example, the side-lying positioning pad is secured in relation to the thoracic support portion 312 such that a load applied thereagainst is sensed by the force plate 302. In performing a side-lying chiropractic lumbar spine adjustment technique, or other vertebral regions in various embodiments, signals from the load plate 302 and sensor 222 may be concurrently recorded for processing and analysis. To avoid introducing erroneous readings induced by the weight of the trainee on the platform 300 that may not be integrally linked to the performed procedure, the weight support 324 may be used such that any weight applied thereto is directed to the leg support portion base 310 and not the independent thoracic support portion 312. This particular embodiment empowers more accurate estimates of the loads acting through the mannequin or the spine of a human simulated patient. The side posture position can be used, however, without the lateral pad or trainee weight support. In such instances, the acquired values will still be representative of the implemented procedure, but will generally differ from actual values. That being said, on a day-to-day comparison basis, change in values will correctly represent change in skill of performance.

With reference to FIG. 21, and in accordance with another embodiment, a training mannequin 700 is shown to generally define a human torso model having a rigid upper (thorax) portion 702 and a rigid lower (lumbar/pelvic) portion 704 relatively articulated and maintained at a distance from one another by an anchored load sensing unit 706 embedded therein around a spinal region thereof. The mannequin further comprises an articulated head portion 708 mounted to the upper portion 702 via a flexible coupling 709, for example such as flexible couplings 120 and 220 described above within the context of mannequins 100 and 200 illustrated in FIGS. 1 to 6.

In this particular embodiment, the upper portion 702 and the lower portion 704 are predominantly manufactured from a molded, cast or otherwise formed rigid human model (e.g. rigid plastic such as polyurethane) that is either molded as a singular unit and then separated around the lumbar region (e.g. around L3/L4) posteriorly and around the umbilicus anteriorly, or as distinct portions to exhibit such separation. The upper and lower portions are then coupled to one another via installation of the load-sensing unit 706 therebetween, in this example, within an internal cavity 710 defined to coextend within the upper and lower portions, respectively. As will be appreciated by the skilled artisan, the cavity 710 may be defined during formation of the torso model, or again post formation. In some embodiments, the two portions are separated by a thin (e.g. 0.5 cm to 2.0 cm) gap that will be filled post assembly with a deformable material, thus allowing for relative bending in flexion, lateral flexion and/or axial rotation. As will be appreciated, the gap may vary in accordance with different embodiments without departing from the general scope of the present disclosure, and is shown to be relatively larger in the illustrated example for the sake of clear illustration.

With added reference to FIG. 22, and in accordance with one embodiment, the sensing unit 706 generally comprises a first rigid vertebral model 712 and a second rigid vertebral model 714 (i.e. L3 and L4 models, respectively, in this example, manufacture of rigid polyurethane) rigidly attached to one another by way of a tri-axial load sensor 716 or the like, for example, one capable of measuring 3D forces and moments between them, such as the ATI Force/torque sensor Mini 45. In this configuration, the sensor 716 may effectively act as an intervertebral sensor without interfering with manual palpations of the mannequin during training. The sensing unit 706 in this example further comprises opposed anchoring extensions 718 capable of withstanding limited axial torque and each terminating into respective spaded anchors 720 to be embedded within the cavity 710 of the upper and lower torso portions 702, 704, respectively.

In one embodiment, material properties are selected to accommodate an effective maximum peak-to-peak moment torque around 50 Nm (e.g. with a 2× safety factor) without fracture, a relative twist of 50 degrees or less during axial twisting performed during relevant manual therapy maneuvers, and an average torsional stiffness of around 0.23 Nm per degree with hardened spring behavior.

Measures of load passing through the model can be displayed, as discussed below, as load-time profiles and/or compared with on-board library references to inform the user on relative anatomical movements and limits to guide the conduct of these maneuvers (e.g. during training).

With continued reference to FIG. 21, the mannequin 700 may have embedded therein, respective head and lumbar kinematic sensors 722 and 724, respectively, so to measure relative kinematics between the head and torso during execution of a selected treatment procedure. For example, in one embodiment, respective gyroscope/accelerometer/inclinometer combinations (e.g. InvenSense MPU-9150) are embedded within the head and torso of the mannequin 700 along the mid-sagittal and mid-coronal planes, oriented coplanar when the mannequin 700 is in neutral position of the head with respect to the thorax. Accordingly, measured signals generated from each set of sensors during manual treatment maneuvers can be used to calculate the relative kinematics including displacement, velocity and/or acceleration of the head with respect to the trunk. These values can be displayed in time-series profiles and/or compared with on-board library references to inform the user on relative anatomical movements and limits to guide the conduct of these maneuvers. As will be appreciated by the skilled artisan, other types of sensors may be considered, as well as different positions therefor, and that, in different combinations and/or configurations to accommodate the measure of different procedural metrics in qualifying and/or quantifying one's execution of selected manipulative treatment procedures.

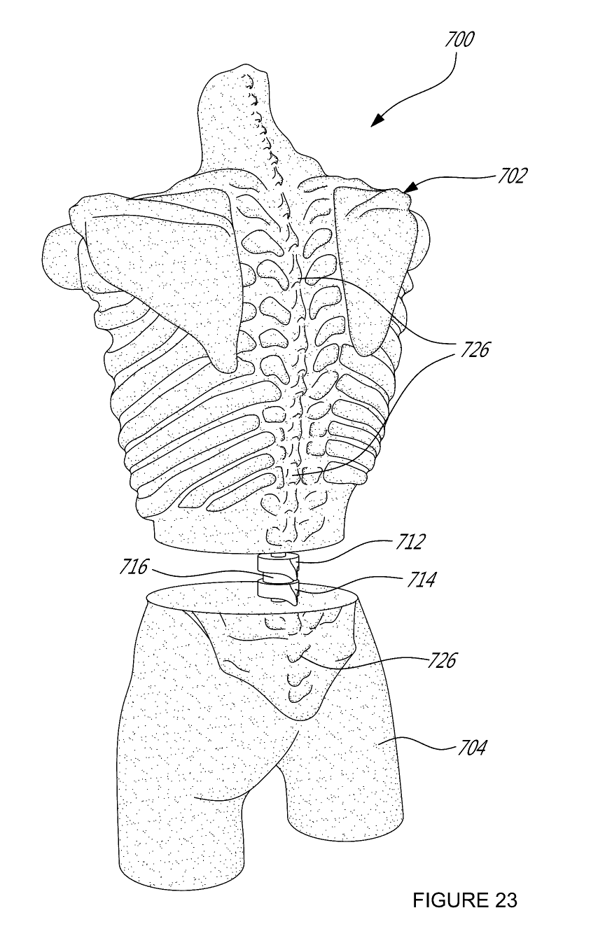

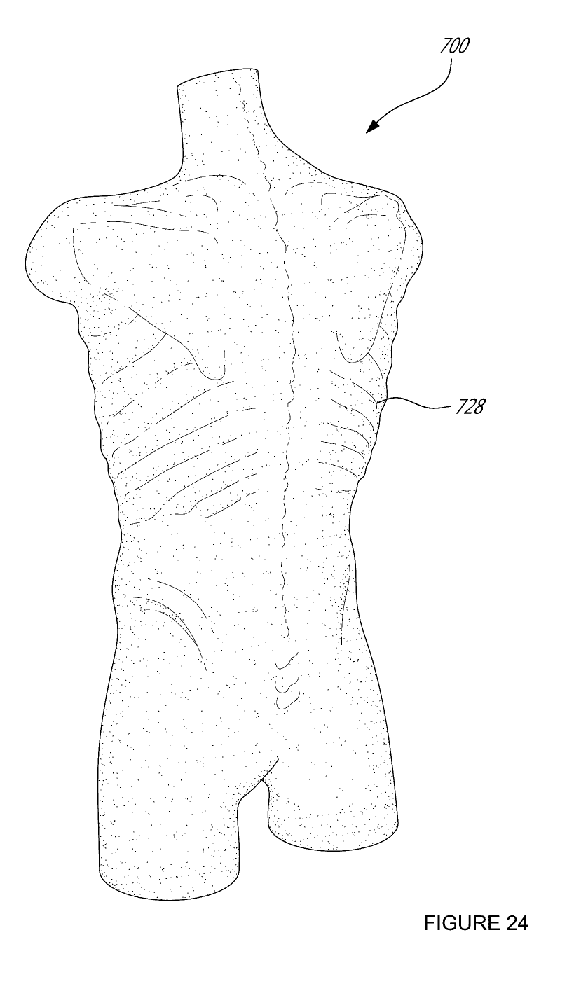

With reference now to FIGS. 23 and 24, and in accordance with one embodiment, the mannequin 700 may be manufactured to exhibit a rigid anatomically-scaled artificial human spine structure, such as that formed by a set of anatomically-shaped spine surface features 726 formed, cast or moulded within the rigid upper and lower torso portions 702 and 704, respectively. Other physiological markers, such as clavical, shoulder blade, pelvic rim, sacrum, ribs, humeral head, and sternum markers, to name a few, may also be formed in the model(s).

In this example, the first and second vertebral models 712 and 714 of the sensing unit 706 also exhibit spine surface features which, upon assembly within the torso model, provide continuity between the spine surface features 726 formed within the upper and lower portions 702 and 704. Accordingly, the sensing unit 706 not only provides for an articulated assembly of the upper and lower portions 702, 704, but also provides for a continuous spinal palpation guide along the mannequin's spinal region, which can be used as a guide in the localization and performance of selected manipulative treatment procedures during training.

As best shown in FIG. 24, the core of the mannequin 700 is then embedded within (i.e. covered with) a resilient foam compound layer 728, such as that described above, such that a compliance thereof is substantially consistent with an estimated compliance of live human torso soft tissue. This same or other compound may be used to fill the gap between the upper and lower portions of the torso, though other materials may be considered to achieve distinct deformation properties, for example.

With reference now to FIG. 10, and in accordance with one embodiment, a manipulative treatment training system, generally referred to using the numeral 400, will now be described. The system 400 generally comprises a training mannequin, such as mannequin 200 as illustrated in FIGS. 5 and 6 (or mannequin 100 as illustrated in FIGS. 1 to 4, or mannequin 700 as illustrated in FIGS. 21 to 24), a support platform 300 (e.g. such as that shown in FIGS. 7 to 9), and a visual feedback system provided to give trainees visual qualitative and/or quantitative feedback as to their performance of various designated training sequences and techniques. In this example, the feedback system comprises a graphical user interface 402, rendered on one or more display screens 404 and implemented by a computing platform (not explicitly shown) operatively coupled to the system's various feedback tools and equipment to gather and process relevant data signals and provide visual feedback to the system's users (e.g. trainees and/or instructors) as to their performance. In this example, the system 400 draws from the mannequin's embedded sensors 222 to extract a feedback response indicative of a direct pressure applied to the mannequin by the trainee; from the support platform's load plate 302 to extract a feedback response indicative of a load profile applied to the mannequin by the trainee; and from a head-end (408) and a pair of ceiling-mounted angled foot-end (406) video cameras concurrently operated to render multi-angle visual feedback as to the trainee's physical execution of the training sequence of technique in question. The load information data provided from the sensors and the video data from video cameras may, in some embodiments, be combined to evaluate and provide feedback to the trainee or instructor as to the trainee's execution of a given technique as discussed below.

In an alternative embodiment, the table sensing system may be used for more advanced training where the mannequin is replaced by live simulated patients or actual patients to measure and refine manual treatment procedures, thus still benefiting from load data acquired via the table, optionally in combination with video feedback data to be consulted concurrently for better performance assessment and improvement.

In yet other embodiments operating with a mannequin 700 such as that illustrated in FIGS. 21 to 24, lumbar load-sensing unit data and relative head/torso kinematics data may also or alternatively be acquired to provide training feedback.

The graphical user interface 402 combines, in this embodiment, one or more force-time profile windows 410 in which force-time profiles extracted from the force plate 302 may be displayed in real-time and/or playback mode (e.g. including, but not limited to any one or more the following channels: Fx, Fy, Fz, Mx, My, Mz, and/or one or more derived data channels and/or derived profile quantization such as described above); a level curve window 412 in which a change in direction of the forces applied during a designated procedure can be mapped (i.e. where a perfectly stable direction of force would consist of a single point on the graph, and where the shorter the path length, the less variable is the force direction); a video playback interface 414 for each camera angle, and direct applied force measures (not explicitly shown) extracted from the embedded sensors 222. The interface may further include a set of control functions to provide one or more of the following:
a) start, stop and save various measures, profiles and video recordings for a given trainee, training procedure, etc.;
b) identify a selected training action from a list of designated training actions, for recordal purposes and also optionally to load designated calibration parameters and/or standard profiles usable in qualitatively and/or quantitatively comparing trainee action to performance standards;
c) playback controls for video playback in juxtaposition with acquired, stored and/or playback of transmitted or applied load and/or pressure or motion profiles;
d) system calibration functions, for example in setting new designated treatment action parameters, again to acquire and/or load new performance standards for new or existing training actions, or again interface with various system equipment to ensure or test proper function; and p1 e) administrative functions for setting new user accounts, manage stored data and/or data outputs, interface with system equipment to set up new, or maintain existing functions and communication interfaces.
f) practical training testing; and
g) direct evaluation of procedure components and derived quantities during phases of the procedure in isolation or in combination, which may provide knowledge of results for direct feedback and modification of performance to reference standards.

Other interface features and functions may also be considered within the present context without departing from the general scope and nature of the present disclosure. For example, data acquisition and rendering functions associated with acquired lumbar load-sensing unit data and/or relative head/torso kinematics data may also be considered when operating the system with the mannequin 700 as shown in FIGS. 21 to 24.

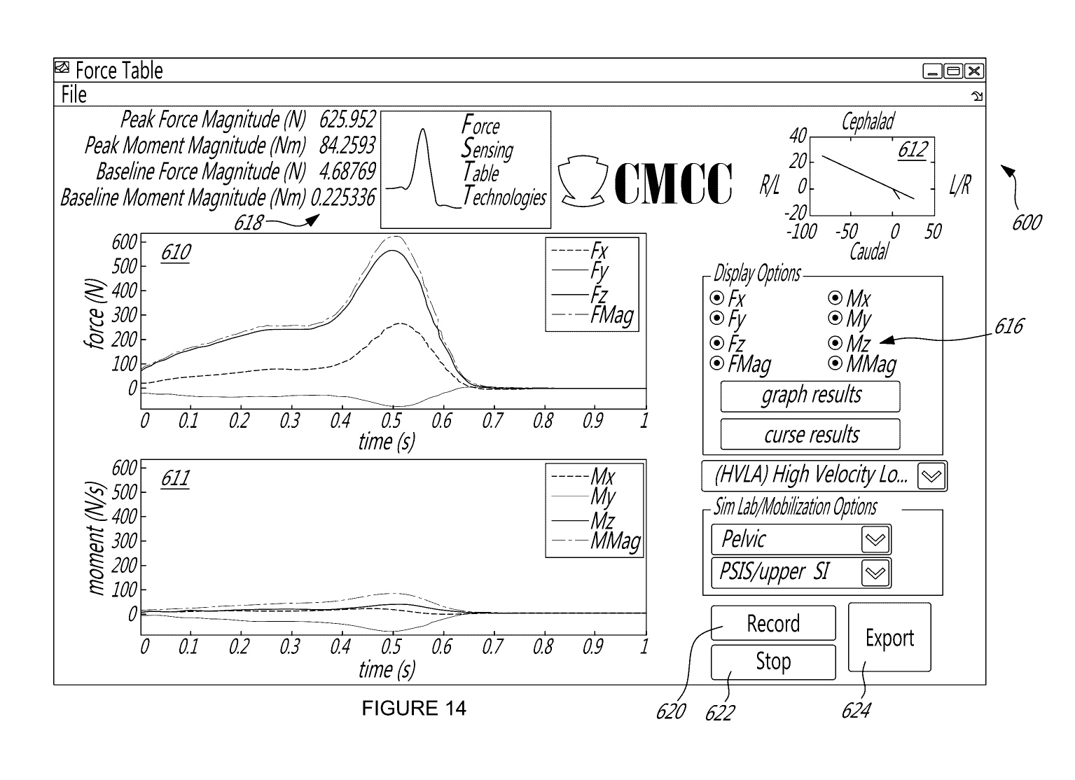

With added reference to FIGS. 14 to 20, an exemplary graphical user interface (GUI) 600 will now be described in accordance with one illustrative embodiment. In this embodiment, the GUI 600 includes a force-time profile window 610 in which force-time profiles extracted from the force plate 302 may be displayed in real-time and/or playback mode (e.g. including, but not limited to any one or more the following selectable channels: Fx, Fy, Fz, and FMag, relaying calibrated time-based measures of a vectorial force applied in the X, Y, Z directions along with a temporal overall force magnitude (FMag) profile). The GUI also includes a moment-time profile window 611 in which moment-time profiles extracted from the force plate 302 may be displayed in real-time and/or playback mode (e.g. including, but not limited to any one or more the following selectable channels: Mx, My, Mz, and MMag, relaying calibrated time-based measures of a vectorial moment applied in the X, Y, Z directions along with a temporal overall moment magnitude (MMag) profile). A level curve window 612 is also provided in which a change in direction of the forces applied during a designated procedure can be mapped.

A “Display Options” portion 616 is also dynamically rendered allowing for selection of any one or more of these force and moment channels, and also allowing for selection between a “graph results” and “curse results” option, the former rendering a completed graph post-processing, while the latter rendering channel data in real-time. Quantified measures are also provided on the GUI via a data output portion 618, which in this example, includes a readout of a calculated Peak Force Magnitude, Peak Moment Magnitude, Baseline Force Magnitude and Baseline Moment Magnitude. “Record”, “Stop”, and “Export” buttons (620, 622 and 624, respectively) are also graphically rendered for managing data acquisition and export.

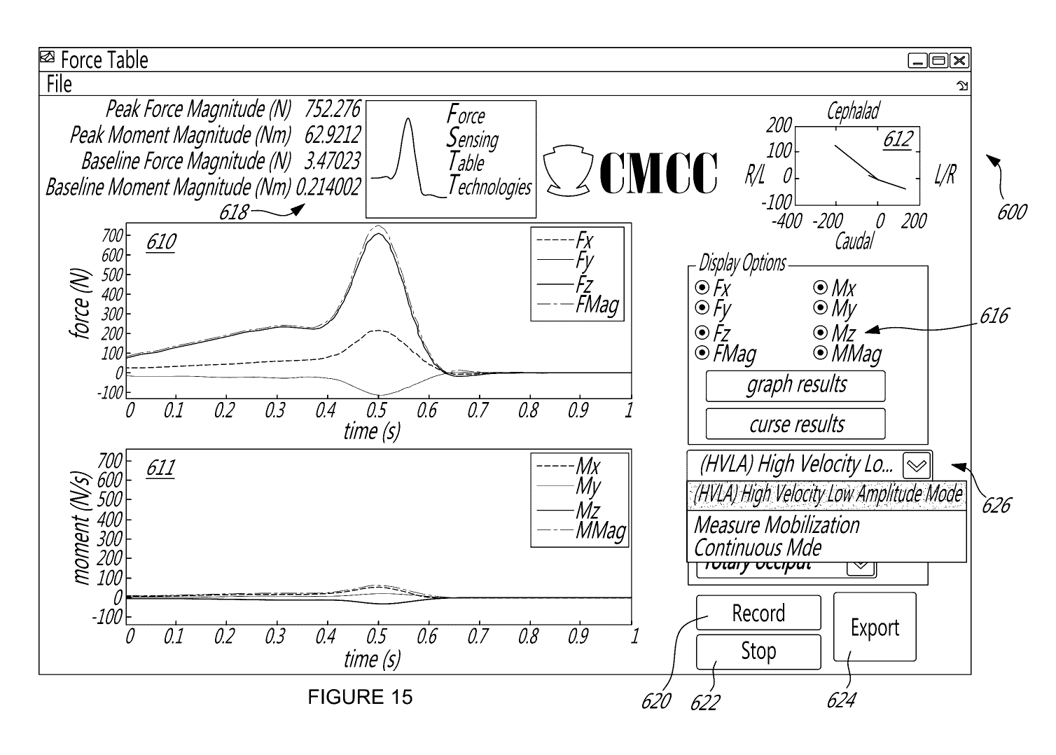

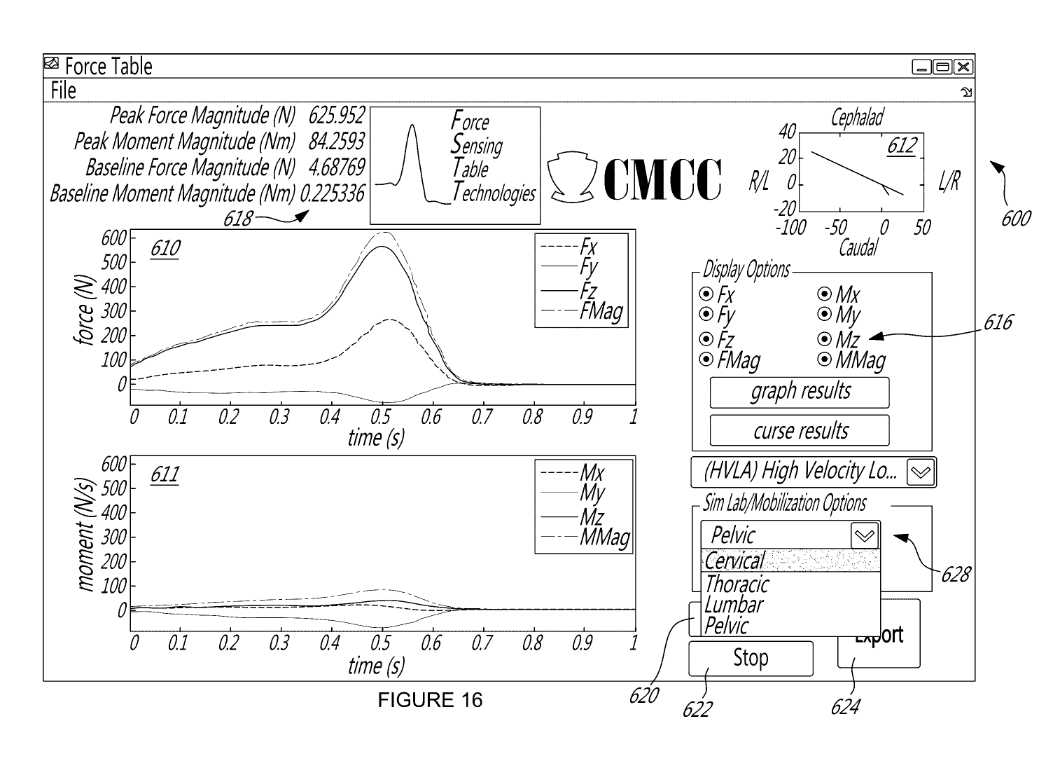

In this example, and with particular reference to FIG. 15, a data acquisition mode selector 626 is also rendered, allowing the user to select between a High Velocity Low Amplitude (HVLA) acquisition mode, a Measure Mobilization mode and a Continuous mode. For example, the Measure Mobilization mode may be preset to render appropriate measures during simulated mobilizations where gentle pressures and/or maneuvers may b applied to the mannequin or candidate and quantified for visualization by the system user. For instance, in this mode, temporal force or moment profiles may be less illustrative of proper application, as compared to overall force or moment magnitudes and or directions. Accordingly the Measure Mobilization mode 640 may be associated with preset recording parameters conducive to providing instructional feedback to the candidate applying these simulated or actual mobilizations. Upon selection of the Measure Mobilization mode, the GUI 600 will provide access to selectable Mobilization options via a Body Region selector function 628, best seen in FIG. 16 to provide selectable options for Cervical, Thoracic, Lumbar and Pelvic procedures. Upon selection of a given body region option, a respective system calibration will be invoked applying an appropriate calibration to acquired force/moment data to render geometrically accurate and representative results, for instance in vectorially extrapolating applied forces/moments sensed by the force plate to a selected body region of interest, and further, in respect of a selected treatment procedure and/or mannequin/subject/patient configuration. Furthermore, while not explicitly shown in the illustrated embodiment, the system may be further configured to extrapolate a force applied to the body or mannequin by extrapolating an applied force on the load plate, to not only one that is recalibrated or re-centered as a function of the selected body region or procedure, but also one extrapolated through the body or mannequin to provide an estimate of the applied force on the body or mannequin in completing the procedure.

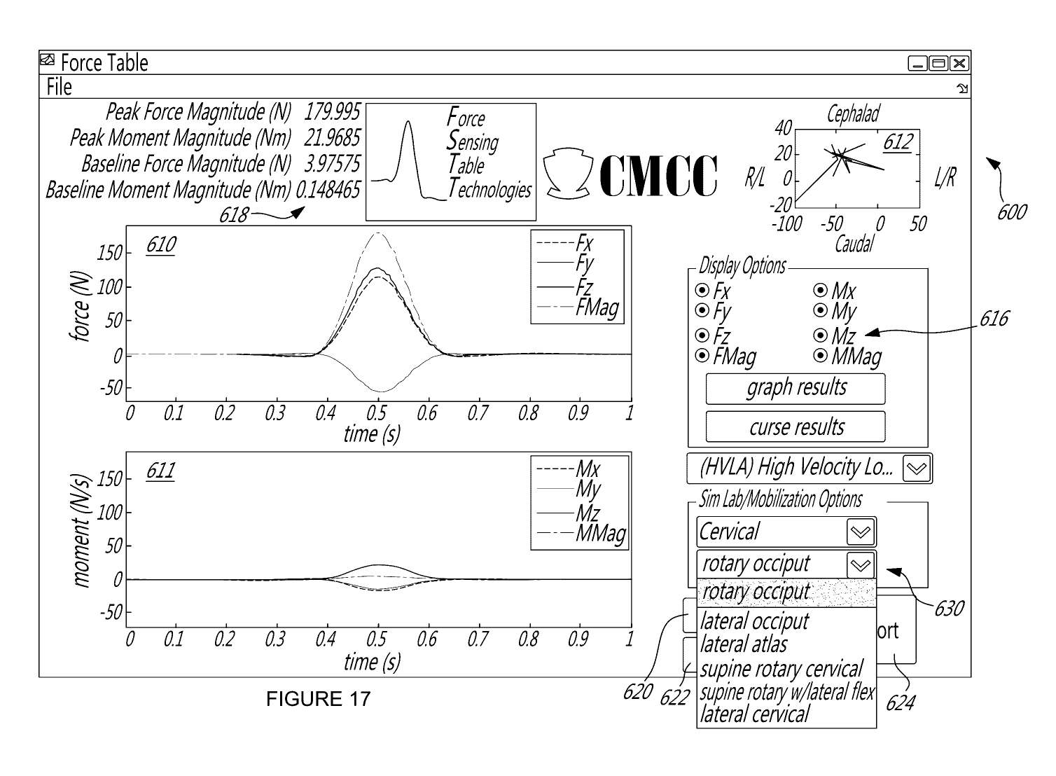

To further illustrate these options, FIGS. 14 to 20 provide illustrative results for the selection of various body and simulation functions with the system operated in the HVLA mode, illustratively shown to be graphically selected in FIG. 15. In FIG. 16, the Cervical Body Region option is selected using the Body Region selection tool 628, and in FIG. 17, a “rotary occiput” procedure option is illustratively graphically selected from a dynamically populated procedure selection tool 630, which, given selection of the Cervical Body region option 646, provides the following list of selectable procedures: rotary occiput, lateral occiput, lateral atlas, supine rotary cervical, supine rotary w/lateral flex, and lateral cervical, for example. The force-time profile window 610 and moment-time profile window 611 show sampled force and moment data acquired during implementation of the selected procedure and calibrated in accordance with procedure-specific calibration metrics defined for this particular procedure.

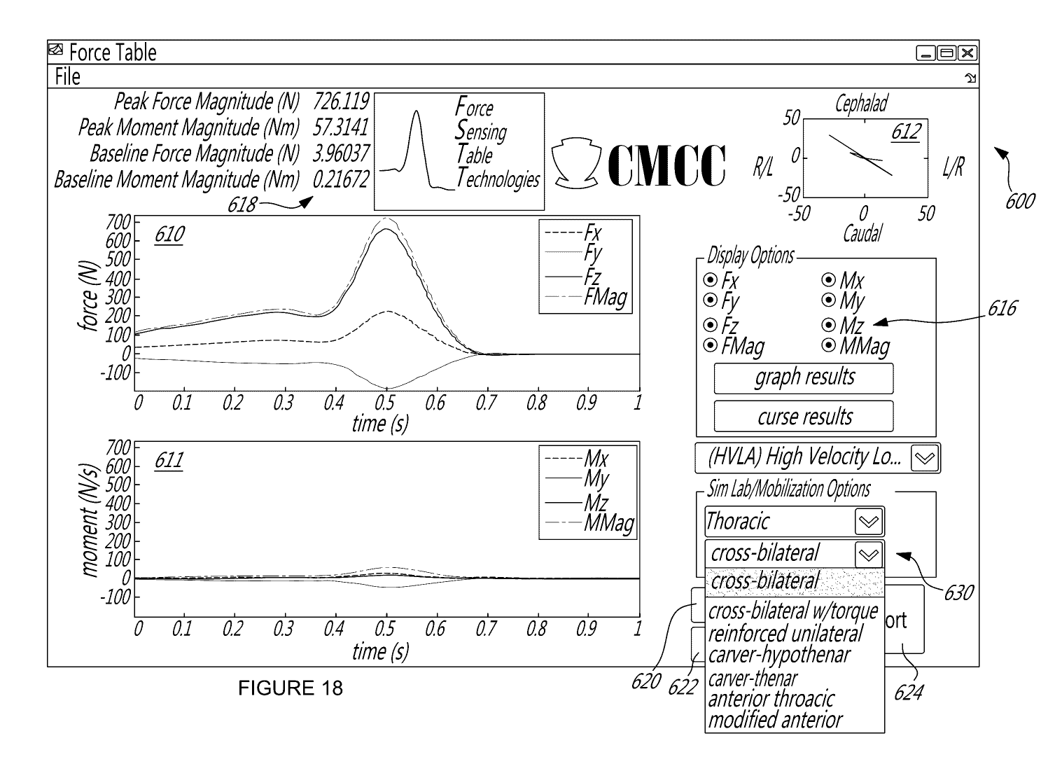

At FIG. 18, the Thoracic Body Region option is rather selected from the Body Region selection tool 28, and a cross-bilateral procedure option selected form the procedure selection tool 630 rendering the following dynamically populated list of exemplary procedure options: cross-bilateral, cross-bilateral w/torque, reinforced unilateral, carver-hypothenar, carver-thenar, anterior thoracic, modified anterior. Corresponding time-profiles are again shown post procedure-specific calibration in data windows 610 and 611.

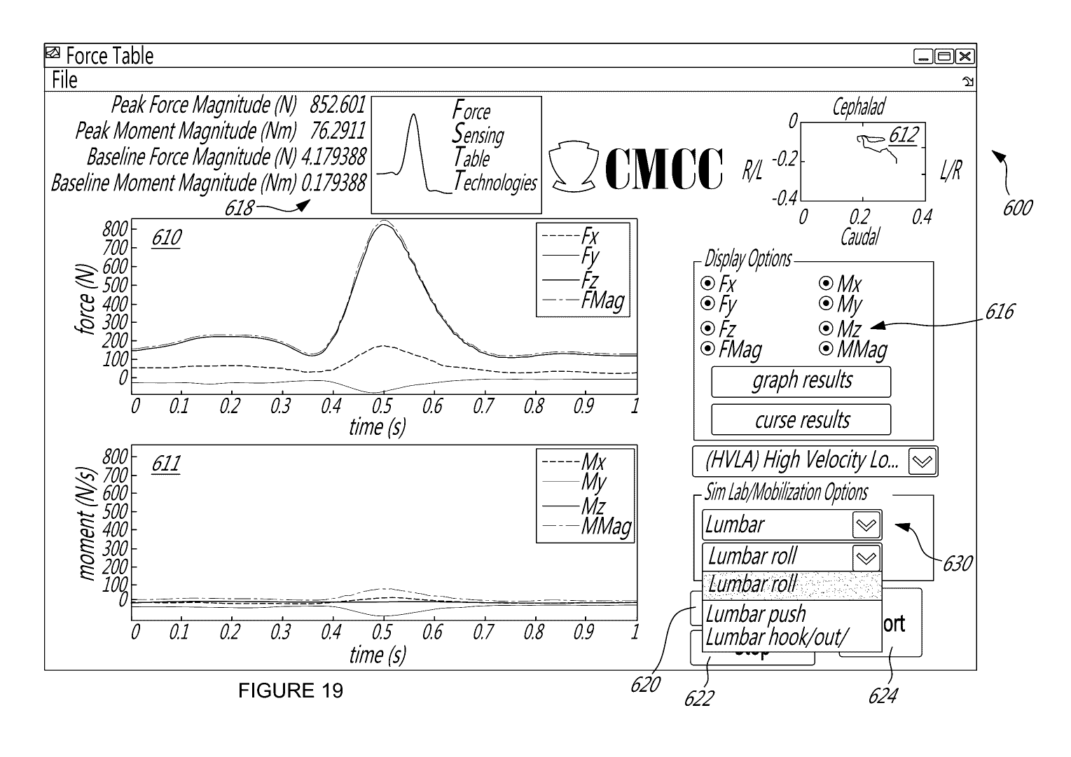

At FIG. 19, the Lumbar Body Region option 650 is rather selected from the

Body Region selection tool 628, and a lumbar roll procedure option selected form the procedure selection tool 630 rendering the following dynamically populated list of exemplary procedure options: lumbar roll, lumbar push, and lumbar hook/pull. Corresponding time-profiles are again shown post procedure-specific calibration in data windows 610 and 611.

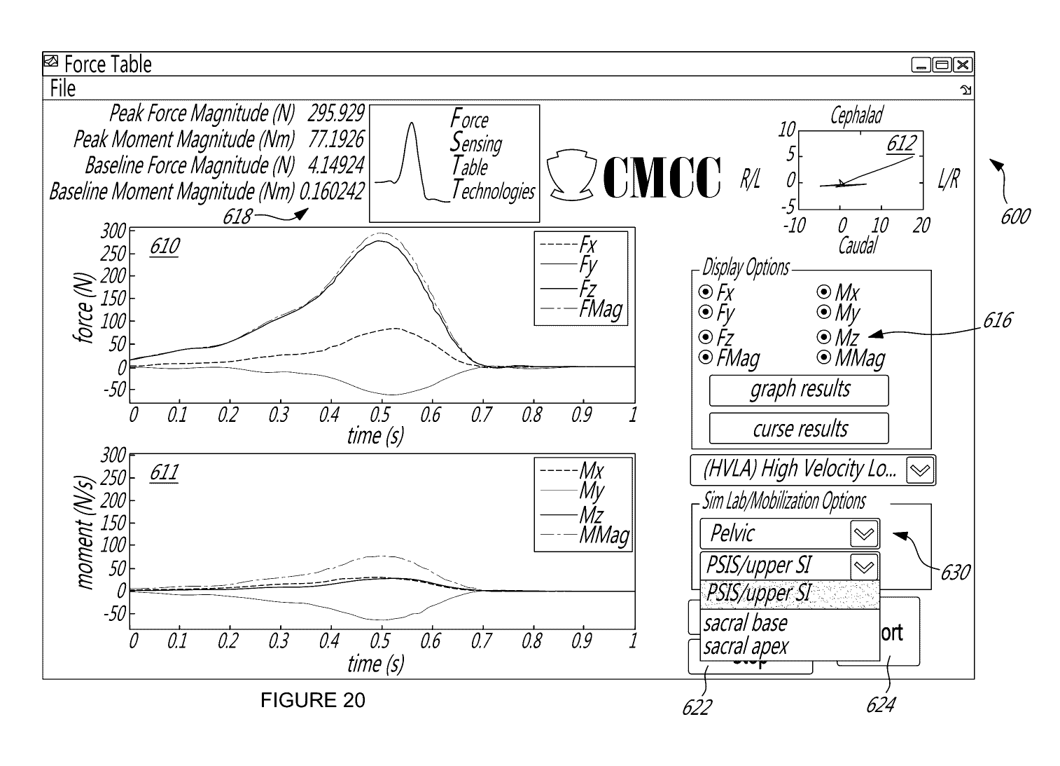

At FIG. 20, the Pelvic Body Region option is rather selected from the Body Region selection tool 628, and a PSIS/upper SI procedure option selected form the procedure selection tool 630 rendering the following dynamically populated list of exemplary procedure options: PSIS/upper SI, sacral base, and sacral apex. Corresponding time-profiles are again shown post procedure-specific calibration in data windows 610 and 611.

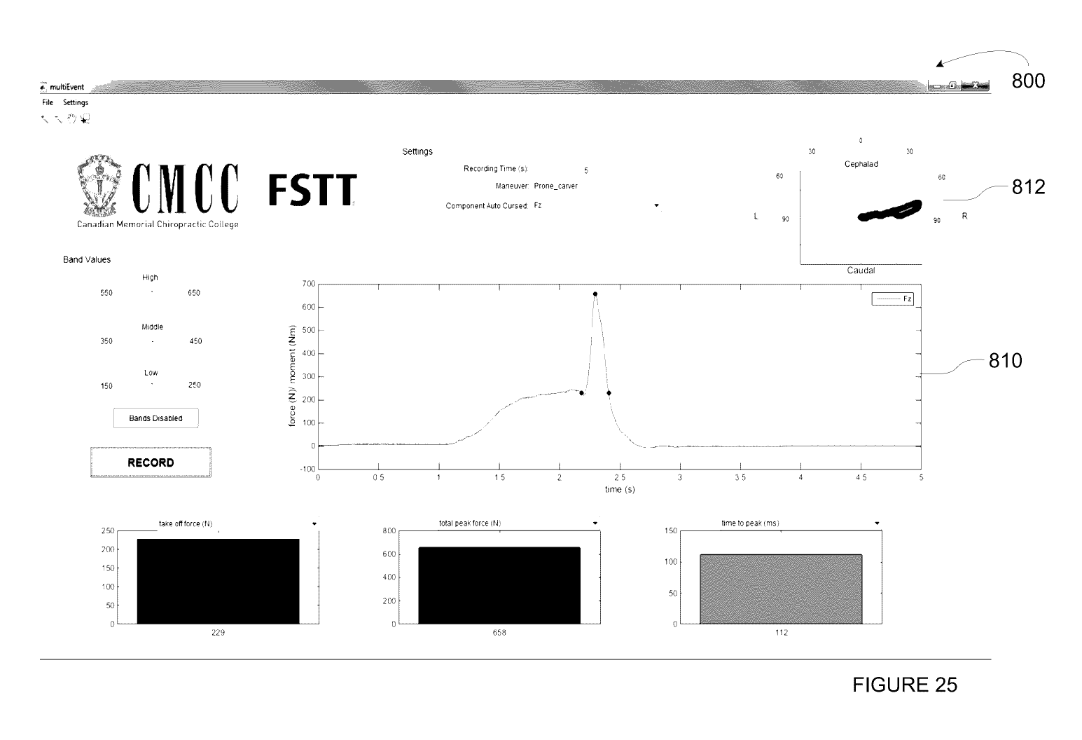

With reference now to FIGS. 25 to 31, an alternative graphical user interface (GUI) 800 will now be described. In this embodiment, the GUI 800 again includes a force-time profile window 810 in which force and/or moment vs. time profiles may be displayed in real-time and/or playback mode. A level curve window 812 is also provided in which a change in direction of the forces applied during a designated procedure can be mapped.

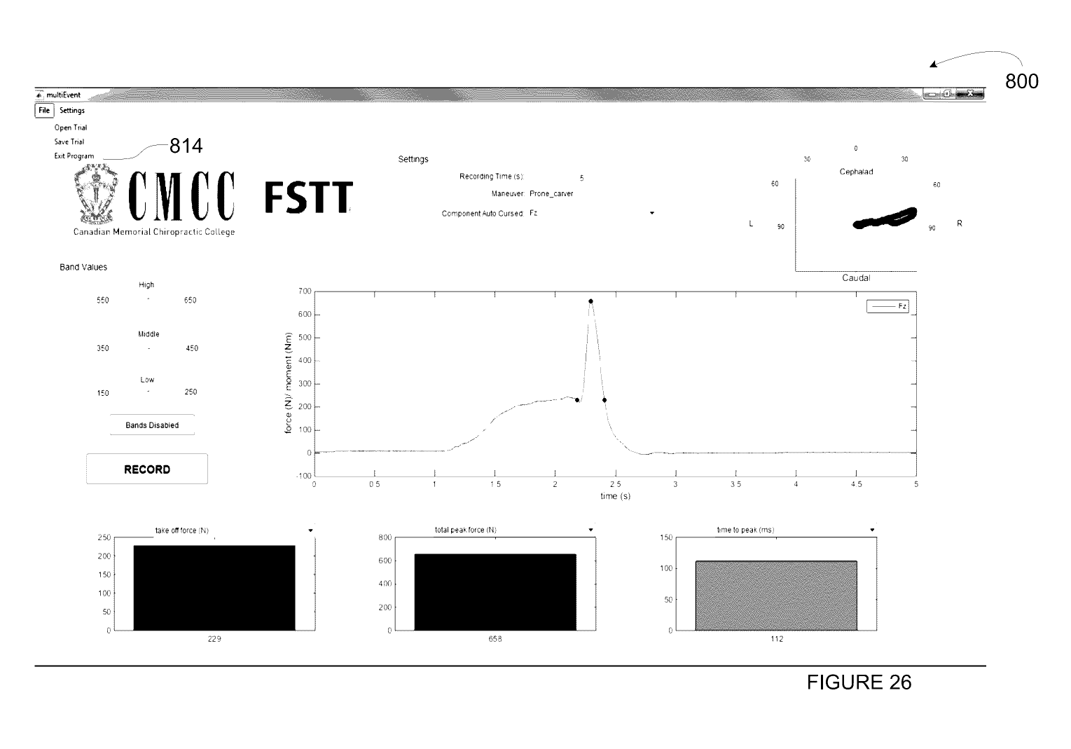

A “file” function 814 is shown in FIG. 26 that allows the user to open a pre-existing trial or save a newly acquired trial.

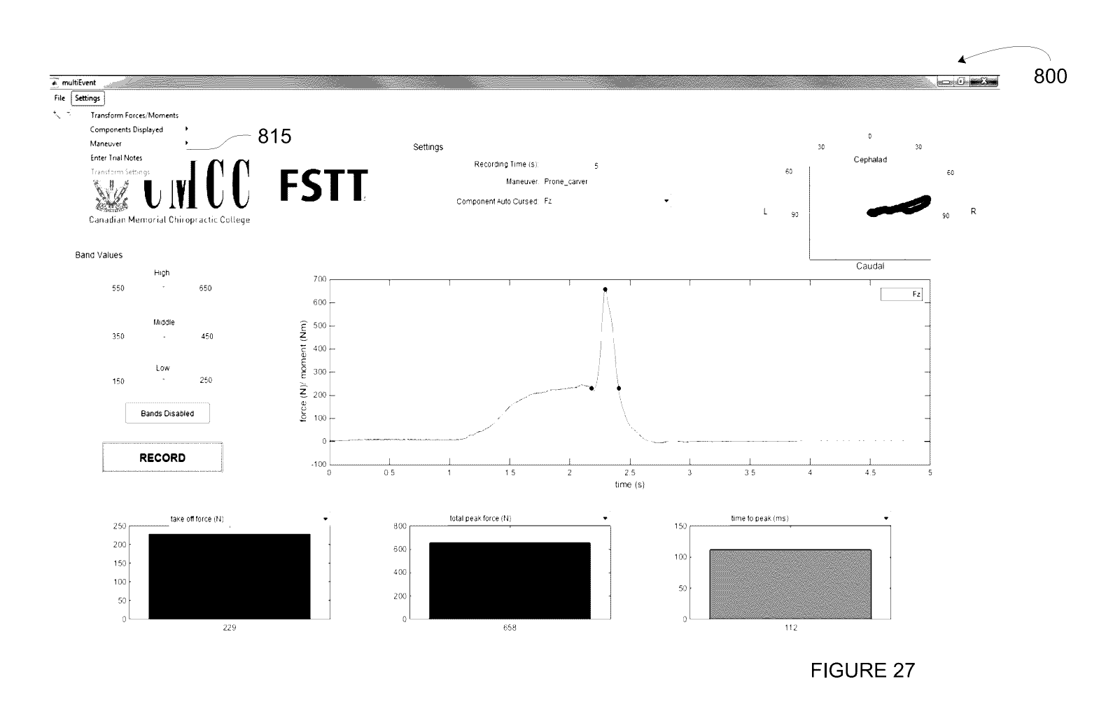

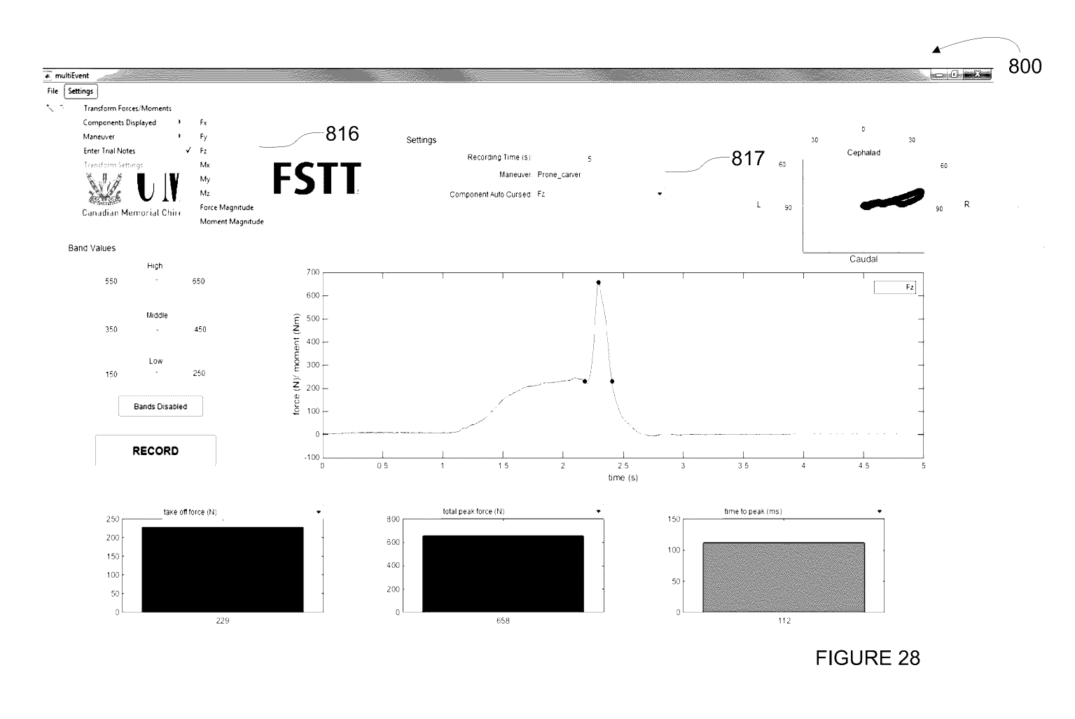

As shown in FIG. 27, different settings 815 may be selected for edit. For instance, a “Components Displayed” setting 816 can be accessed, as shown specifically in FIG. 28, so to select a particular force or moment component for display. In the illustrated example, a downward force (Fz) is selected for display for a 5-second recording interval, as dynamically displayed by a dynamic settings area 817, which also allows for the dynamic adjustment of the selected force/moment component of interest via a corresponding drop down menu.

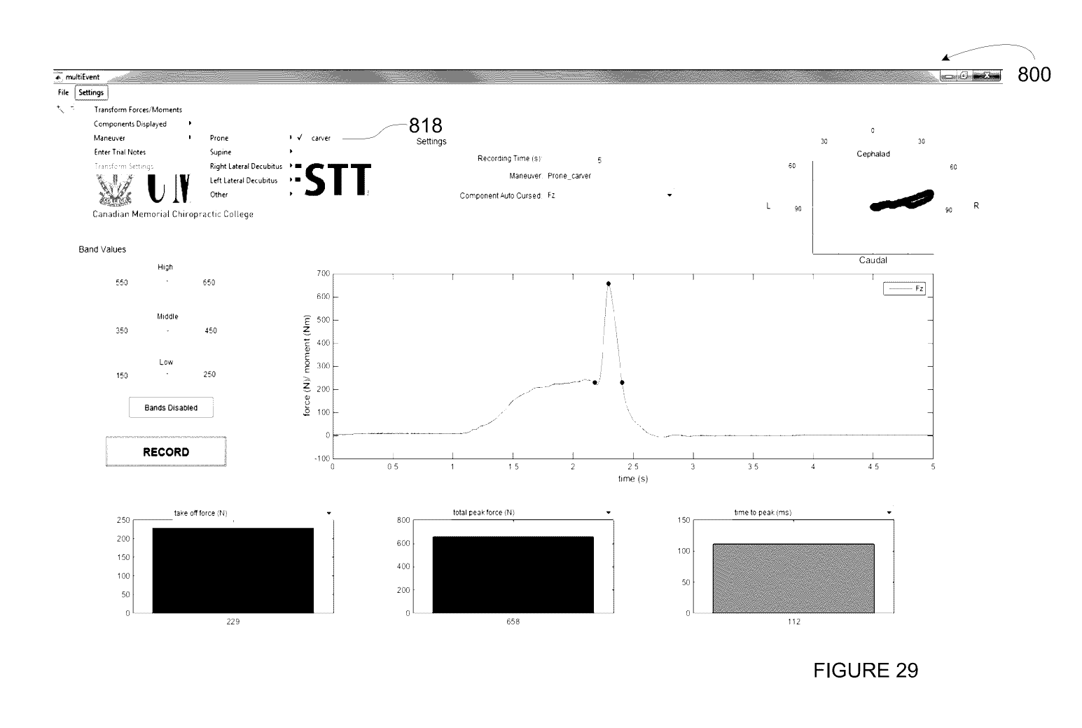

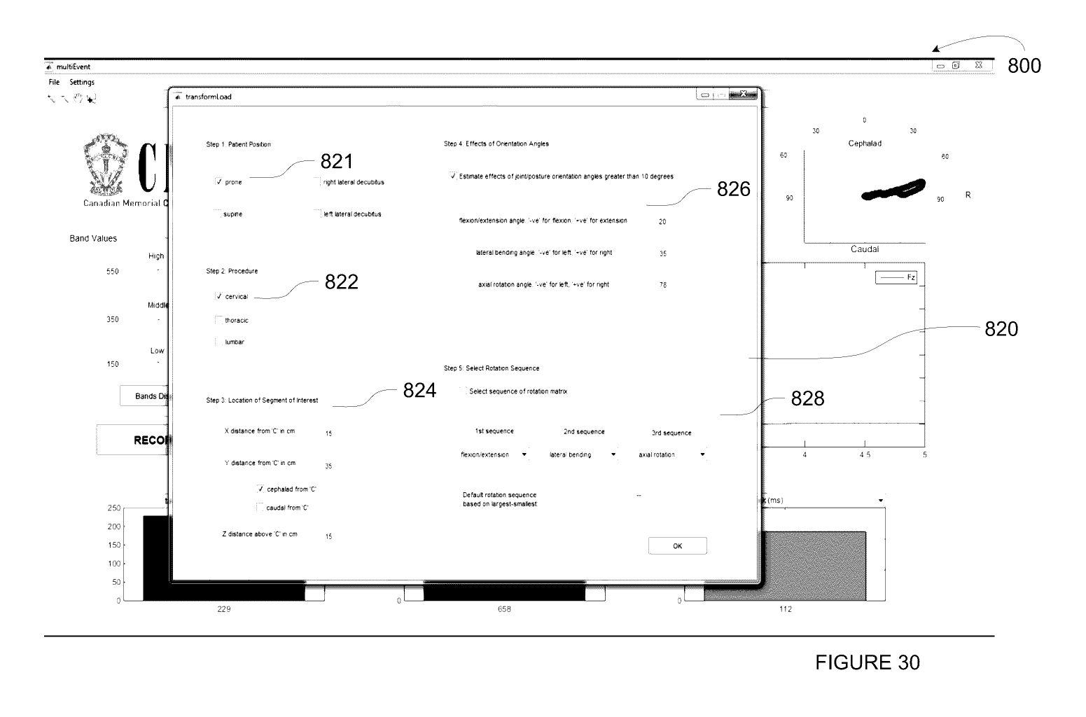

As shown in FIG. 29, a “Maneuver” setting 818 may be dynamically adjusted so to select a particular manipulative treatment procedure, categorized in this example by a patient configuration (e.g. prone). The user may also select to customize transform force/moments to be applied to the acquired force plate data in calibrating this acquired data in accordance with the treatment procedure to be executed. Exemplary user-customizable calibration parameters can be adjusted in the illustrated example via a dedicated dynamic transform load input form 820 also accessible via the settings function, and shown specifically in FIG. 30. In this dynamic form, the user may set/confirm the patient position (e.g. prone) 821, a selected procedure (e.g. cervical) 822, and a location of the segment of interest from the force plate center (e.g. x, y and z distances) 824. The user may also select to take into account effects associated with joint/posture orientation angles 826, and specify estimated flexion/extension angles, lateral bending angles, and axial rotation angles, for example. The order in which a rotation sequence will be applied can also be specified at 828, or taken as the largest to smallest rotation as default.

As above, the load transformation option enables the forces/moments to be expressed from the frame of reference at the application of force. For example, when load transformations are turned off, the forces/moments displayed in the GUI correspond to what the force plate underneath the thoracic section of the table sees; these forces/moments are expressed with respect to the coordinate system of the force plate. Rather, the system can be calibrated, as discussed above, to more accurately express forces/moments as applied at the point of application of force (i.e. at the hand-body interface), that is, to take into account that the actual point of force/moment application is some distance and at some angle from the force plate. Accordingly, by specifically identifying the general displacement and angle of the hand relative to the center of the force plate, the actual “hand force” can be properly calculated and used to output feedback measures through the GUI. To do so, as discussed above, vectorial data output from the force plate is process through a series of rotation matrices (i.e. roll, pitch, yaw), that take into account the body position of the subject/patient, and outputs the force/moments at the ‘hands’. Some of the theory behind these calculations was described by Grood and Suntay (Grood, E. S., & Suntay, W. J. (1983). A joint coordinate system for the clinical description of three-dimensional motions: application to the knee.Journal of biomechanical engineering, 105(2), 136-144.), the entire contents of which are hereby incorporated herein by reference.

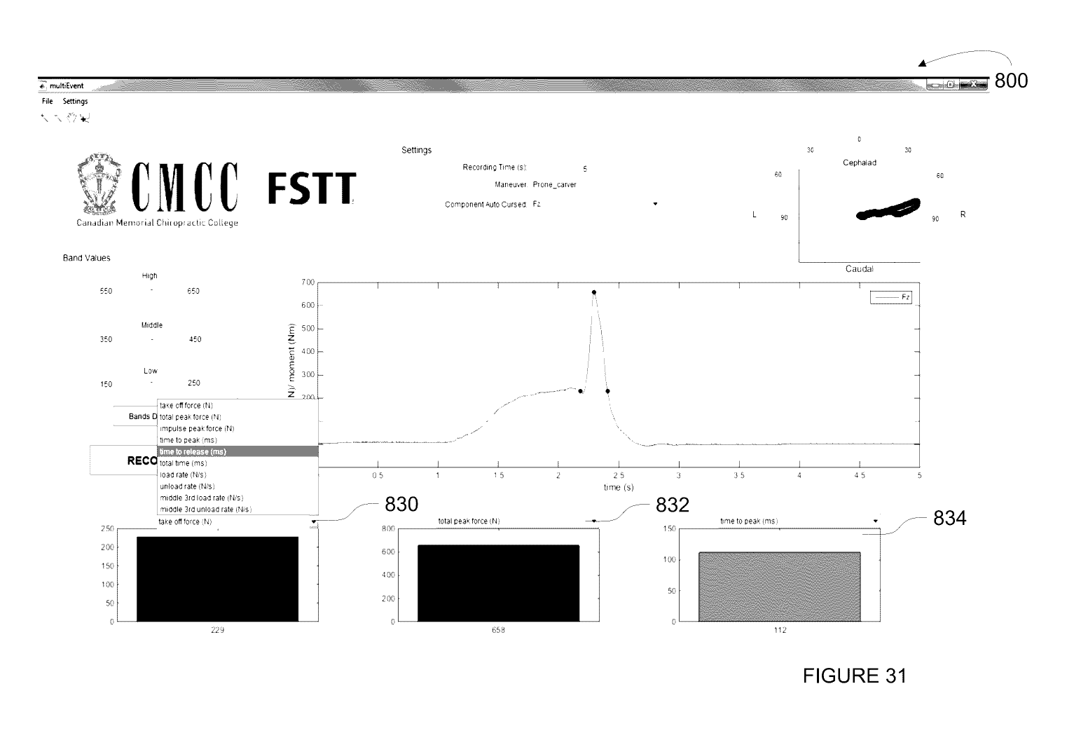

With specific reference to FIG. 31, quantified measures are also provided on the GUI 800 via a data output portion, which in this example, includes three dynamically selectable measurement readout graphs selectively showing via corresponding drop down menus, a measured take off force 830, a total peak force 832, and a time to peak measurement 834.

While not shown in these examples, preloaded values and/or profiles may also be associated with each selectable procedure to provide comparative feedback to the user. Alternatively, a user may first observe a certified practitioner execute a selected procedure, to then practice and adjust they approach to this selected procedure in seeking to replicate or mimic the force/moment outputs produced by the certified practitioner. Furthermore, while the exemplary embodiment of FIGS. 14 to 20 focus on the acquisition and rendering of time-profiles of applied loads to the support platform, a similar interface may also, or alternatively allow for the rendering of applied pressure measures as acquired for example via embedded mannequin sensors such as sensors 224 shown in FIGS. 5 to 8, or lumbar load-sensing unit data and/or relative head/torso kinematics data as acquired from embedded sensors such as shown in FIGS. 21 to 24.

Accordingly, the graphical user interface described above not only allows for the informative and educational rendering of platform load, applied mannequin pressure, internal mannequin lumbar load and/or relative body kinematics data to the user, but also provides a treatment-selection tool allowing user-selection of a selected procedure from multiple designated treatment procedures to produce output data calibrated/adjusted specifically as a function of the selected treatment procedure, or at least, as a function of an anatomical region predominantly affected by this selected procedure. Furthermore, while some embodiments may come preloaded with particular designated treatment procedures, some embodiments may also or alternatively allow for user customization of such treatment selection tools, such as in the providing of customizable drop-down menus and the like. In order to accomplish such treatment-specific calibrations, the GUI data will generally be rendered by a processor operatively associated with a computer-readable medium or the like having stored thereon a respective procedure-specific calibration metric for each of multiple designated treatment procedures selectable via the GUI. For instance, each metric may take into account one or more of a designated or preset standard application point on the body or mannequin relative to the load plate, for example, for the selected procedure, a general direction of the applied load at that point, and other parameters relevant in characterizing the origin and dynamics of the procedure in question. Accordingly, upon selection of a given treatment procedure via the GUI, the data processor, responsive to this user-selection, will apply the appropriate procedure-specific calibration metric stored in memory and associated with the user-selection to the data acquired via the load sensor(s) or other sensors. Clearly, where multiple sensors are used, appropriate calibrations may be implemented to account for such multiple sensors. It will be appreciated that the GUI, processor and/or computer-readable medium may be provided in the context of a dedicated data processing device or the like having an output screen and peripheral inputs to receive load signal data directly or indirectly from the load-sensing plate/sensor(s). Alternatively, the load signal(s) may be input to a general purpose computer or the like implementing a dedicated software application or the like stored on the computer's memory and invoked by the computer's general processor in rendering the GUI on an associated or peripheral display screen or the like, while operating on commands and instructions stored in memory associated with this software application to provide results as discussed above.

Accordingly, system users may gain further feedback as to the performance of various treatment procedures and techniques, as well as monitor their progress by loading past performances and comparing these results with stored or available performance standards. For example, qualitative and quantitative feedback may be provided in real-time and/or over time as to the practitioner's general force application and direction profiles (e.g. consistent with steady and consistent industry standards), and as to the various components thereof such as, in the context of chiropractic and/or other manual therapy procedures, preloaded forces/moments and profiles, peak force/moment amplitude, and derived quantities to include speed of force/moment production, duration of impulse, to name a few, as well as consistency of applied force direction, stability, etc. Overtime, such measures may be compounded into statistical analyses as to the candidate's performance and improvement over time, as well as to isolate potential directions of improvement and/or typical shortcomings for which other training efforts or techniques may be prescribed. Concurrent with direct external pressure measurements which may provide further qualitative and/or quantitative measures as to the trainee's performance, as well as video feedback to identify various facets of the trainee's physical posture during, and physical execution of designated techniques, a more complete assessment as to the trainee's performance, shortcomings and attributes may be achieved on the spot for immediate consideration and, where appropriate, rectification thus reducing the learning curve and likely resulting in better overall training and professional qualification.

As will be appreciated by the skilled artisan, while the above focuses on the practice of spinal-region treatments, the above-described system may also be considered for other regions of the body, either on an appropriately adapted mannequin, or again on live simulated or actual patients. For example, different manipulative treatment techniques may also be practiced on extremity joints, either for direct observation via the force plate of the support platform, or via one or more harnesses and/or aids, such as illustrated above with reference to FIGS. 8 and 9 in the treatment of side-lying candidates.

While the present disclosure describes various exemplary embodiments, the disclosure is not so limited. To the contrary, the disclosure is intended to cover various modifications and equivalent arrangements included within the general scope of the present disclosure.

What is claimed is:

1. A manipulative treatment training system comprising:
a support platform for supporting a subject or training mannequin, said support platform having one or more load sensors operatively associated therewith to output a signal indicative of a load applied over time to at least part of said support platform via said subject or mannequin while performing a selected one of multiple designated manipulative treatment procedures thereon;
a graphical user interface defining a treatment-selection tool allowing user-selection of said selected procedure from said multiple designated treatment procedures, and graphically rendering a procedure-specific data output derived from said signal;
a computer-readable medium having stored thereon a respective procedure-specific calibration metric for said selected treatment procedure; and
a data processor operatively associated with said computer-readable medium and graphical user interface, said processor, responsive to said user-selection of said selected procedure via said graphical user interface, applying said respective procedure-specific calibration metric associated with said selected procedure to said signal to output said procedure-specific data to said graphical user interface;
wherein said respective procedure-specific calibration metric accounts for at least one of a predefined relative vectorial distance and direction of said selected procedure to vectorially re-center said output data consistent with a designated load application configuration for said selected procedure; and
wherein said output procedure-specific data comprises vectorially re-centered procedure-specific load-related time profiles extrapolated from said load applied over time.

2. The system as defined in claim 1, wherein said one or more load sensors are operatively disposed in association with an independent thoracic support portion of said support platform, and wherein each said procedure-specific calibration metric accounts for a geometrical configuration of the subject or training mannequin during said selected procedure relative to said thoracic support portion.

3. The system as defined in claim 1, wherein said one or more load sensors are operatively disposed in association with an independent thoracic support portion of said support platform, and wherein said at least one of said predefined relative vectorial distance and direction are relative to said thoracic support portion.

4. The system as defined in claim 1, wherein said treatment-selection tool comprises a body region selection tool for selecting a selected anatomical body region to which is to be applied said selected procedure; and a procedure selection tool that, responsive to a body region selection being made via said body region selection tool, dynamically renders one of a user-selectable list of said multiple procedures and a user-definable procedure, available in respect of said selected body region.

5. The system as defined in claim 1, wherein said respective procedure-specific calibration metric is defined at least in part by user-customizable calibration parameters.

6. The system as defined in claim 1, wherein said computer-readable medium has further stored thereon respective execution standards data for each of said multiple designated treatment procedures, and wherein said graphical user interface is operable to concurrently render accessed standards data against said a procedure-specific data for comparative feedback purposes.

7. The system as defined in claim 1, wherein said load-related time profiles comprise at least one of a vectorial force-time profile and a vectorial moment-time profile.

8. The system as defined in claim 6, wherein said accessed standards data comprises vectorially calibrated standard procedure-specific load-related time profiles.

9. The system as defined in claim 1, wherein the system is a chiropractic treatment training system and wherein said selected procedure comprises a selected chiropractic treatment procedure.

10. A non-transitory computer-readable medium having statements and instructions stored thereon for implementation by a digital data processor to operate a manipulative treatment training system in:
graphically rendering a treatment-selection tool allowing user-selection of a selected manipulative treatment procedure from multiple designated treatment procedures;
accessing a given digital procedure-specific calibration metric from a data store associated with said selected manipulative treatment procedure;
acquiring an applied load signal output over time in response to performance of said selected manipulative treatment procedure;
applying said given procedure-specific calibration metric to said signal to output calibrated procedure-execution feedback data; and
graphically rendering said calibrated procedure-execution feedback data;
wherein said given procedure-specific calibration metric accounts for at least one of a predefined relative vectorial distance and direction of said selected treatment procedure to vectorially re-center said applied load signal output consistent with a designated load application configuration for said selected treatment procedure; and
wherein said calibrated procedure-specific feedback data comprises vectorially re-centered procedure-specific load-related time profiles extrapolated from said applied load signal over time.

11. The computer-readable medium as defined in claim 10, wherein said applied load signal is output from a support platform configured to support a subject or training mannequin during performance of said selected manipulative treatment procedure, said support platform having one or more load sensors operatively associated therewith to output said signal indicative of said load applied to at least part of said support platform via said subject or mannequin while performing said selected manipulative treatment procedure.

12. The computer-readable medium as defined in claim 11, wherein said one or more load sensors are operatively disposed in association with an independent thoracic support portion of said support platform, and wherein each said procedure-specific calibration metric accounts for a geometrical configuration of the subject or training mannequin during said selected procedure relative to said thoracic support portion.

13. The computer-readable medium as defined in claim 11, wherein said one or more load sensors are operatively disposed in association with an independent thoracic support portion of said support platform, and wherein said at least one of said predefined relative vectorial distance and direction are relative to said thoracic support portion.

14. The computer-readable medium as defined in claim 10, wherein said treatment-selection tool comprises a body region selection tool for selecting a selected anatomical body region to which is to be applied said selected procedure; and a procedure selection tool that, responsive to a body region selection being made via said body region selection tool, dynamically renders one of a user-selectable list of said multiple procedures and a user-definable procedure, available in respect of said selected body region.

15. The computer-readable medium as defined in claim 10, wherein said given digital procedure-specific calibration metric is defined at least in part by user-customizable calibration parameters input via said treatment-selection tool.

16. The computer-readable medium as defined in claim 10, wherein said statements and instructions are further executed to operate the manipulative treatment training system in accessing stored standards data representative of a standard execution of said selected procedure; and concurrently rendering said accessed standards data against said calibrated procedure-execution feedback data for comparative purposes.

17. The computer-readable medium as defined in claim 16, wherein said accessed standards data comprises vectorially calibrated standard procedure-specific load-related time profiles.

18. The computer-readable medium as defined in claims 17, wherein said selected procedure comprises a selected chiropractic treatment procedure.

19. A computer-implemented manipulative treatment training method comprising:
graphically rendering, via a digital processor, a treatment-selection tool allowing user-selection of a selected manipulative treatment procedure from multiple designated treatment procedures;
accessing, via said digital processor, a given digital procedure-specific calibration metric from a data store associated with said selected manipulative treatment procedure;
acquiring, via said digital processor, an applied load signal output over time in response to performance of said selected manipulative treatment procedure;
applying, via said digital processor, said given procedure-specific calibration metric to said signal to output calibrated procedure-execution feedback data; and
graphically rendering, via said digital processor, said calibrated procedure-execution feedback data.
wherein each said procedure-specific calibration metric accounts for at least one of a predefined relative vectorial distance and direction of said selected procedure to vectorially re-center said output data consistent with a designated load application configuration for said selected procedure; and
wherein said output procedure-execution feedback data comprises vectorially re-centered procedure-specific load-related time profiles extrapolated from said applied load signal over time.

20. The method as defined in claim 19, wherein said load-related time profiles comprise at least one of a vectorial force-time profile and a vectorial moment-time profile.

21. The method as defined in claim 19, further comprising:
accessing, via said digital processor, stored standards data representative of a standard execution of said selected procedure; and
concurrently rendering, via said digital processor, said accessed standards data against said calibrated procedure-execution feedback data for comparative purposes.

22. The method as defined in claim 21, wherein said accessed standards data comprises vectorially calibrated standard procedure-specific load-related time profiles.

23. The method as defined in claim 19, wherein said applied load signal is output from a support platform configured to support a subject or training mannequin during performance of said selected manipulative treatment procedure, said support platform having one or more load sensors operatively associated therewith to output said signal indicative of said load applied to at least part of said support platform via said subject or mannequin while performing said selected manipulative treatment procedure.

24. The method as defined in claim 19, wherein said selected procedure comprises a selected chiropractic treatment procedure.
